(19) United States
(12) Patent Application Publication
(10) Pub. No.: US 2025/0281886 A1
(43) Pub. Date: Sep. 11, 2025

(54) REDUCED GRAPHENE OXIDE FORWARD OSMOSIS MEMBRANES, AND FABRICATION METHODS AND APPLICATIONS OF SAME

(71) Applicant: BOARD OF TRUSTEES OF THE UNIVERSITY OF ARKANSAS, Little Rock, AR (US)

(72) Inventor: Wei Zhao, Little Rock, AR (US)

(21) Appl. No.: 19/072,168

(22) Filed: Mar. 6, 2025

Related U.S. Application Data
(60) Provisional application No. 63/562,568, filed on Mar. 7, 2024.

(51) Int. Cl. B01D 71/02; B01D 61/00; B01D 67/00; B01D 69/02; B01D 69/10; C01B 32/198; C01B 32/23; C02F 1/44

(52) U.S. Cl. CPC B01D 71/0211; B01D 61/0022; B01D 61/005; B01D 67/0044; B01D 67/0083; B01D 69/02; B01D 69/107; C01B 32/198; C01B 32/23; C02F 1/445; B01D 2313/345; B01D 2325/24; B01D 2325/30; C02F 2303/10

(57) ABSTRACT

One aspect of the invention relates to a forward osmosis (FO) membrane including a selectively permeable active layer formed of a graphene-based material with tunable interlayer spacing; and a support membrane providing mechanical stability. The FO membrane enhances water flux while minimizing reverse solute flux.

### CROSS-REFERENCE TO RELATED PATENT APPLICATION

This application claims priority to and the benefit of U.S. Provisional Patent Application Ser. No. 63/562,568, filed Mar. 7, 2024, which is incorporated herein in its entirety by reference.

### STATEMENT AS TO RIGHTS UNDER FEDERALLY-SPONSORED RESEARCH

This invention was made with government support under Contract No. 80NSSC19C0565 awarded by the National Aeronautics and Space Administration. The government has certain rights in the invention.

### FIELD OF THE INVENTION

The invention relates generally to the field of materials, and more particularly, to reduced graphene oxide forward osmosis membranes, and fabrication methods and applications of the same.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

With a salinity gradient, forward osmosis (FO) processes move water across a semipermeable membrane from a lower salinity solution into a higher salinity solution using naturally occurring osmotic pressure rather than external hydraulic pressure. Thus, FO provides a near zero-energy approach for water treatments, with applications ranging from osmotic dilution prior to desalination, treatment of high salinity brines, wastewater volume reduction, water recovery from wastewater, fertigation, and emergency water supply. However, the current FO membranes such as cellulose triacetate (CTA, FTSH₂O) undergo physical degradation due to the mechanical damage by scaling under crossflow conditions. They may also suffer from the loss of membrane integrity when used with strong oxidants such as hexavalent chromium Cr (VI) due to possible chemical degradation by Cr (VI) oxidation. In addition, the CTA FO membranes are sensitive to chlorine (maximum chlorine 2 ppm as recommended by the manufacturer). Similarly, polyamide-based membranes are also hypersensitive to chlorine. In addition to better physical stability and chemical compatibility, the effects of reverse solute flux need to be considered. Using divalent draw solutes has a potential for the solutes to pass across the FO membrane and exceed saturation once combined with brackish groundwater or the seawater, leading to scaling on the active layer. Therefore, FO membranes with large reverse flux selectivity are of great interest.

On the other hand, there is substantial osmotic energy stored in the FO processes due to the high salinity difference between the feed solution and the draw solution With improved mechanical strength and antifouling capability, the RGO membranes could be used for osmotic energy harvesting with further optimization, extending the useful lifetimes of the membrane-packed modules which is one of limiting factors in applications of reverse electrodialysis (RED) and pressure retarded osmosis (PRO). However, harvesting the osmotic energy while simultaneously concentrating waste brine has not been implemented in the FO processes, which warrants further investigation.

Therefore, a heretofore unaddressed need exists in the art to address the aforementioned deficiencies and inadequacies.

### SUMMARY OF THE INVENTION

In one aspect, the invention relates to a forward osmosis (FO) membrane, comprising a selectively permeable active layer formed of a graphene-based material with tunable interlayer spacing; and a support membrane providing mechanical stability; wherein the FO membrane enhances water flux while minimizing reverse solute flux.

In one embodiment, the support membrane is a polymeric support membrane comprising nylon, polyethersulfone (PES), mixed cellulose ester (MCE), cellulose acetate, and/or polycarbonate (PC) with a pore size ranging from 0.03 μm to 0.8 μm.

In one embodiment, the free interlayer spacing is less than 0.7 nm after water exposure.

In one embodiment, the graphene-based material comprises reduced graphene oxide (RGO).

In one embodiment, the RGO active layer exhibits a reverse flux selectivity of at least 6700 L/mol when tested with a 1.5 M sodium sulfate draw solution.

In one embodiment, the RGO active layer is formed by thermally reducing graphene oxide (GO) sheets that are pre-treated with hydrogen peroxide oxidation and hydrothermal reactions to create nanoporous structures.

In one embodiment, the interlayer spacing of the RGO active layer is tunable by varying the annealing temperature between 150-190° C.

In one embodiment, the RGO active layer is adhered to the polymeric support membrane, providing enhanced mechanical stability as demonstrated by resistance to tape peel tests.

In one embodiment, the FO membrane exhibits resistance to chlorine degradation at concentrations exceeding 2 ppm and resistance to hexavalent chromium (Cr VI) oxidation.

In one embodiment, the FO membrane exhibits rejection rates exceeding 99.8% for salts and organic species in synthetic urine tests.

In one embodiment, the FO membrane demonstrates enhanced mechanical strength and chemical resistance against degradation by oxidizing agents. In one embodiment, the FO membrane is used for selective chemical enrichment and desalination processes, separation and concentration of chemical species in industrial or environmental applications.

In one embodiment, the FO membrane is designed for long-term operational stability in high-salinity and wastewater treatment environments.

In one embodiment, the FO membrane is integrated into a hybrid desalination system in combination with ion exchange or reverse osmosis for improved brine management.

In another aspect, the invention relates to a method for fabricating a forward osmosis (FO) membrane, comprising synthesizing a graphene-based material; depositing the graphene-based material onto a support membrane; and treating the deposited material to enhance stability and selectivity.

In one embodiment, said synthesizing the graphene-based material comprises synthesizing graphene oxide (GO) sheets from natural graphite using an oxidation process; treating the GO sheets with hydrogen peroxide oxidation for 5-10 hours to create nanoporous structures; and subjecting the nanoporous GO sheets to hydrothermal reduction to obtain RGO suspensions.

In one embodiment, said depositing the graphene-based material comprises depositing the RGO suspensions onto a polymeric support membrane via vacuum filtration.

In one embodiment, said treating the deposited material comprises thermally annealing the deposited RGO membrane at a temperature of 150-190° C. to achieve a free interlayer spacing of less than 0.7 nm.

In one embodiment, the support membrane comprises nylon, PES, MCE, cellulose acetate, and/or PC with a pore size ranging from 0.03 to 0.8 μm.

In one embodiment, the method of further comprises an additional post-treatment step to enhance adhesion between the RGO layer and the support membrane, improving mechanical robustness.

In yet another aspect, the invention relates to a forward osmosis system, comprising an FO membrane as claimed above; a feed solution chamber containing wastewater or brackish water; and a draw solution chamber containing a high-salinity solution; wherein the FO membrane simultaneously enables water transport while minimizing reverse solute flux and allows for osmotic energy harvesting as electrical energy.

In one embodiment, the FO system further comprises electrodes positioned in the feed and draw solution chambers to capture osmotic energy as electrical output.

In a further aspect, the invention relates to a method for harvesting osmotic energy, comprising utilizing a forward osmosis membrane as claimed in claim 1 to separate a high-salinity draw solution from a lower-salinity feed solution; allowing osmotic flow across the membrane to generate an ion flux; capturing the resulting electrochemical potential using electrodes to produce an open-circuit voltage; and converting the captured energy into usable electrical power.

In one embodiment, the draw solution comprises sodium sulfate or sodium chloride at concentrations of 1.0-2.0 M.

In one embodiment, the osmotic energy is stored as an electrochemical charge for use in low-power electronic devices, sensors, or IoT (Internet-of-Things) applications.

In one aspect, the invention relates to a forward osmosis membrane-based osmotic battery, comprising a stack of FO membranes as claimed in claim 1, arranged in a series-parallel configuration; alternating feed and draw solution compartments to maintain salinity gradients; and an electrical circuit to collect and regulate the generated osmotic energy.

In one embodiment, the FO membranes are printed using a gravure printing technique and thermally reduced in situ to produce large-area RGO membranes for scalable energy applications.

In one embodiment, the osmotic battery operates in an off-grid environment utilizing wastewater or brine as a feed solution to generate renewable energy.

In another aspect, the invention relates to a method for producing large-area RGO FO membranes, comprising depositing GO sheets onto a flexible substrate using a blade coating or gravure printing technique; thermally reducing the GO layer in situ using a controlled heat gun technique; and transferring the thermally reduced RGO membrane onto a polymeric support membrane for FO applications.

These and other aspects of the present invention will become apparent from the following description of the preferred embodiments, taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. The same reference numbers may be used throughout the drawings to refer to the same or like elements in the embodiments.

FIG. 1 shows schematically showing various factors (A) contributing to the production of a superior RGO-based FO membrane based on size exclusion for ions/molecules and electrostatic repulsion for anions (B). CH and CL are the salt concentrations at the high salt draw solution reservoir and the low salt feed solution reservoir, respectively.

FIG. 2 shows schematic of FO test setup.

FIG. 3 shows TEM images of single sheets of pristine GO (A: Sample #1), GO treated with H₂O₂ for 5 hours (B: Sample #2), and RGO hydrothermally treated from Sample #2 (C: Sample #3). The GO and RGO sheets are supported by a lacey carbon substrate, where the red arrows show the holes on the sheets.

FIG. 4 shows SEM images of GO sheets from suspensions of Sample #1 (pristine GO) and Sample #3 (RGO from 5-hour H₂O₂ treated GO) and their corresponding sheet size distributions (2.2±1.0 μm for Sample #1 and 0.77±0.50 μm for Sample #3).

FIG. 5 shows C1s XPS spectra of GO membranes reacted with H₂O₂ under a period of 0 h (a), 5 h (b), 10 h (c), and 15 h (d). Also shown are the atomic percentage of C and O (e) and the atomic ratio of C—C/C═C carbon (C_{C}) to oxygenated carbon (C_{O}) obtained by XPS analysis (f), plotted against the reaction time.

FIG. 6 shows IR spectra of various GO and RGO samples, a) GO treated with H₂O₂ for 5 h measured at room temperature (GO-5h-RT) and GO-5h after hydrothermal reaction (RGO-5h RT). b) GO samples treated with H₂O₂ at different times. c) GO-5h RT samples annealed at different temperatures in air. d) RGO-5h RT annealed at different temperatures in air. e) GO-5h RT samples annealed at different temperatures in N₂.

FIG. 7 shows thermogravimetric analysis of GO samples under air and N₂ atmospheres.

FIG. 8 shows C1s XPS spectra of GO membranes before thermal annealing (a) and after thermal annealing at 150° C. (b), 190° C. (c), and 230° C. (d). Also shown are the atomic percentage of C and O (e) and the atomic ratio of C and O (f), plotted against the annealing temperature.

FIG. 9 shows XRD patterns (a, b) and interlayer spacings (c, d) of free-standing GO membranes annealed at different temperatures before (a, c) and after (b, d) saturated with water. The insert in FIG. 5c shows the interlayer spacing difference before and after saturated with water. The peak marked with an asterisk in b) is from water-saturated pristine GO sample and has an interlayer spacing of 0.32 nm, less than graphite interlayer spacing 0.34 nm.

FIG. 10 shows bare nylon membrane, GO, RGO-HY, RGO-nHY, and RGO-HA membranes prepared before and after heat treatment. RGO-HY=hydrothermally reduced RGO. RGO-HA=thermally annealed RGO-HY. RGO-nHY=thermally annealed GO without hydrothermal pretreatment.

FIG. 11 shows SEM images of surface morphologies (A) and cross sections under different magnifications (B and C) of bare nylon filter membrane and RGO membranes on nylon filter membranes before and after thermal annealing.

FIG. 12 shows thicknesses of RGO membranes on nylon filter membranes before and after thermal annealing at 155° C., measured from SEM cross-section images in FIG. 6 in the main text.

FIG. 13 shows Jₛ, J_{w}, and J_{w}/Jₛ of RGO membranes on isopore PC membranes with (a) a pore size of 0.1 μm and mass loading of 0.1 mg, and (b) a pore size of 0.2 μm and mass loading of 0.2 mg (area=10.2 cm²), plotted against Na₂SO₄ concentrations. The samples were annealed at 140° C. for 30 min.

FIG. 14 shows Jₛ (a), J_{w} (b), and J_{w}/Jₛ (c) of RGO-nHY and RGO-HA membranes on 0.03 μm pore PES membranes thermally annealed at 230° C., plotted as a function of the reaction time with H₂O₂, with 1.5 M Na₂SO₄ draw solutions. Mass loading is 0.25 mg (area=10.2 cm²).

FIG. 15 shows Jₛ, J_{w}, and J_{w}/Jₛ of RGO membranes on 0.2 μm nylon membranes (1.5 M Na₂SO₄ draw solution), plotted against annealing temperatures (a) and mass loading (b). The RGO mass loading is 1.0 mg in (a), and the annealing temperature is 170° C. in (b). Note that the y axes are in a logarithmic scale.

FIG. 16 shows Jₛ, J_{w}, and J_{w}/Jₛ of RGO membranes with (RGO-HA) or without (RGO-nHY) pretreatment of hydrothermal reactions, annealed at a) 150° C. and b) 170° C. on 0.45 μm nylon membranes with 1.5 M Na₂SO₄ draw solutions. Mass loading is 0.25 mg (area=10.2 cm²).

FIG. 17 shows Jₛ, J_{w}, and J_{w}/Jₛ of RGO membranes treated under different thermal annealing times in nitrogen at 170° C. on 0.45 μm nylon membranes with 1.5 M Na₂SO₄ draw solutions. Note that the y axis in (a) is in a logarithmic scale.

FIG. 18 shows cComparison of reverse salt flux (Jₛ), water flux (J_{w}), and reverse flux selectivity (J_{w}/Jₛ) of RGO membranes 1-5 with those of a CTA membrane under 1.5 M Na₂SO₄ draw solution (a, b) and 1.0 M NaCl draw solution (c, d). The reverse flux selectivity in g/L was also shown for each membrane. RGO1-6 (annealing temperature/mass loading): 1: 170° C./0.08 mg; 2:170° C./0.125 mg; 3:170° C./0.25 mg; 4:160° C./0.25 mg; 5:155° C./0.25 mg; and 6:150° C./0.25 mg.

FIG. 19 shows Jₛ, J_{w}, and J_{w}/Jₛ of RGO membranes on 0.45 μm nylon membranes with 1.5 M Na₂SO₄ draw solution (a) and 1.0 M NaCl draw solution (b), respectively, plotted against annealing temperatures in the air, and of RGO membranes with 1.5 M Na₂SO₄ draw solution, plotted against mass loading (c) and annealing temperatures in N₂ (d). The RGO mass loading is 0.25 mg in a, b, and d (area=10.2 cm²). Note that the y axes are in a logarithmic scale.

FIG. 20 shows a RGO membrane on nylon annealed in N₂ (RGO-HA-N₂) (1), a RGO membrane on nylon annealed in air (RGO-HA-air) (2), and a RGO membrane on nylon with no thermal annealing treatment (RGO-nHA) (3) before (a) and after (b) FO tests. The red arrows in 3b indicate the areas damaged by the O-ring after the FO test.

FIG. 21 shows 1) Tape peel test for RGO on nylon membrane annealed in N₂ (RGO-HA-N₂) before (a), with tape (b), and after (c) tape peeled off. No damage was observed. 2) Tape peel test for RGO on nylon membrane annealed in air (RGO-HA-air) before (a) and after (b) tape peeled off. The red arrow indicates only a small area damaged after the tape was peeled off. 3) Tape peel test for RGO on nylon membrane without thermal annealing treatment (RGO-nHA) before (a) and after (b) tape peeled off. The red arrow indicates the tape-covered area damaged after the tape was peeled off.

FIG. 22 shows comparison of Jₛ, J_{w}, and J_{w}/Jₛ of RGO membranes after tape peel test with those of RGO membranes without tape peel tests (DI water feed solution and 1.5 M Na₂SO₄ draw solution). No significant difference was observed at 95% confidence after the t test.

FIG. 23 shows comparison of Jₛ, J_{w}, and J_{w}/Jₛ of RGO membranes (0.25 mg and nitrogen atmosphere) annealed at different temperatures before (a) and after (b) exposure to DI water for 30 days. The feed solution is DI water, and the draw solution is 1.5 M Na₂SO₄.

FIG. 24 shows comparison of FO performance of a RGO membrane with a CTA membrane (6,000 mg/L Cr (VI) feed solution and 2 M sucrose draw solution, pH 4.05).

FIG. 25 shows recoverable behaviors of the RGO membranes examined by FO tests (Feed solution: DI water. Draw solution: 1 M NaCl solution) for pH 4 (a, b) and pH 7 (c, d).

FIG. 26 shows comparison of conductivity changes (a) of DI water feed solutions and volume changes (b) of 1 M NaCl draw solutions plotted as a function of FO time for a RGO membrane before NaOCl reaction, after NaOCl reaction, and after fully rinsing. The NaOCl solution pH=4.0.

FIG. 27 shows a) Osmotic energy harvesting device setup with four FO cells connected in series with 1 mM NaCl as a feed solution and saturated NaCl as a draw solution. Carbon cloth (PW03 from Zoltek) was used for the electrodes. The device voltage is 2.24 V as shown on the multimeter. b) A red LED light powered by the device. For the four-FO cells, the open-circuit voltage (OCV) varied with typical values from 1.7 to 2.3 V from device to device and from 0.44 to 0.55 V for each individual FO cell.

FIG. 28 shows water flux J_{w} and OCV plotted against FO time for a RGO membrane with Alamogordo Pond 3 as a feed solution and saturated NaCl as a draw solution. Ag/AgCl electrodes were used.

### DETAILED DESCRIPTION OF THE INVENTION

The present invention will now be described more fully hereinafter with reference to the accompanying drawings, in which exemplary embodiments of the present invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting and/or capital letters has no influence on the scope and meaning of a term; the scope and meaning of a term are the same, in the same context, whether or not it is highlighted and/or in capital letters. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the invention or of any exemplified term. Likewise, the invention is not limited to various embodiments given in this specification.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the present invention.

It will be understood that, as used in the description herein and throughout the claims that follow, the meaning of “a”, “an”, and “the” includes plural reference unless the context clearly dictates otherwise. Also, it will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” to another feature may have portions that overlap or underlie the adjacent feature.

It will be further understood that the terms “comprises” and/or “comprising,” or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation shown in the figures. For example, if the device in one of the figures is turned over, elements described as being on the “lower” side of other elements would then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used in this disclosure, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this disclosure, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

Forward osmosis (FO) is an energy-efficient technology used for wastewater management and chemical enrichment. However, existing FO membranes, such as cellulose triacetate (CTA), suffer from physical degradation due to scaling and mechanical damage under crossflow conditions. Additionally, they are chemically sensitive to oxidants like hexavalent chromium (Cr(VI)) and chlorine, which can compromise their integrity. Polyamide-based membranes face similar issues. Another challenge is the reverse solute flux, where divalent solutes can pass through the membrane, leading to scaling and reduced efficiency. There is also potential for harvesting osmotic energy, but current FO processes have not been optimized for this purpose.

The objectives of this invention are to provide technical solutions to address the above noted challenges in the existing FO membranes.

Specifically, the invention discloses thermally reduced graphene oxide (RGO) FO membranes and novel fabrication methods, which offers:

Exceptionally High Reverse Flux Selectivity: RGO membranes achieve a reverse flux selectivity of 6700 L/mol with a 1.5 M sodium sulfate draw solution, which is about 7 times greater than commercial cellulose triacetate (CTA) FO membranes. This ensures high water permeability while minimizing the undesired backflow of draw solutes, a critical limitation in existing FO membranes.

Enhanced Mechanical and Chemical Stability: Unlike commercial FO membranes that suffer from mechanical damage and chemical degradation, RGO membranes exhibit strong adhesion to nylon support layers, resistance to chlorine and Cr (VI) oxidation, and excellent structural integrity even after FO tests and tape peel tests. This extends the membrane's lifespan and makes it more suitable for harsh industrial and environmental conditions.

Enhanced Resistance to Oxidation and Swelling: RGO membranes show improved resistance to Cr (VI) and chlorine, unlike conventional CTA membranes.

Tunable Interlayer Spacing: The interlayer spacing can be precisely controlled through temperature adjustments, ensuring optimal filtration performance. For example, the RGO interlayer spacing is adjustable via thermal annealing, ensuring that free interlayer spacing remains below 0.7 nm after water exposure. This prevents excessive swelling of GO membranes and allows for effective salt and contaminant rejection, thereby optimizing water permeability while rejecting unwanted solutes.

Simultaneous Wastewater Concentration and Osmotic Energy Harvesting: The invention uniquely enables simultaneous brine concentration and osmotic energy harvesting, demonstrating potential for osmotic battery technology to power electronic devices. This dual-functionality has not been implemented in conventional FO processes, making it a groundbreaking advancement in wastewater management and clean energy generation.

Systematic Optimization of Membrane Fabrication: The invention provides a systematic approach to optimizing FO membrane synthesis, including selection of appropriate filter polymers, fine-tuning go purity, sheet size, and oxidation treatment, optimized thermal annealing conditions to achieve the best performance, and this level of optimization has not been reported for RGO-based FO membranes before.

Cost-Effective and Sustainable: Longer membrane lifespan reduces replacement frequency and maintenance costs. Energy-efficient FO process reduces the need for external energy sources. Sustainable materials (graphene-based) contribute to environmentally friendly water treatment solutions. The fabrication method allows for the production of large-area RGO membranes, making them suitable for industrial applications.

The invention represents a major advancement in FO membrane technology by combining nanoporous RGO structures, tunable interlayer spacing, enhanced stability, and dual-functionality for wastewater treatment and energy harvesting. These innovations make RGO membranes more efficient, durable, and versatile than existing commercial FO membranes, paving the way for new applications in sustainable water treatment and clean energy storage.

The fabrication process allows for large-scale production, making RGO membranes commercially viable. The RGO membranes have multiple applications across various fields, including, but are not limited to:

Advanced Water Purification and Wastewater Treatment: Highly efficient FO membranes for desalination and wastewater reclamation. Superior resistance to chemical degradation, especially against chlorine and hexavalent chromium (Cr (VI)), making it ideal for treating industrial and municipal wastewater. Reduced membrane fouling and scaling, leading to longer-lasting membranes and lower maintenance costs.

Selective Chemical Enrichment: The membranes allow for precise separation of solutes, making them useful for recovering valuable chemicals and nutrients from waste streams. Potential applications in pharmaceuticals, mining, and food industries where selective solute extraction is needed.

Osmotic Energy Harvesting and Power Generation: The membrane design enables simultaneous brine concentration and energy harvesting through forward osmosis, contributing to the development of osmotic batteries. Can generate electricity from salinity gradients, which can be used for off-grid power sources and renewable energy applications.

Enhanced Performance in Harsh Environments: Unlike conventional CTA or polyamide-based membranes, RGO membranes maintain integrity in highly saline, oxidizing, and chemically aggressive environments. Suitable for industries such as petrochemicals, textiles, and heavy metal processing, where conventional membranes fail.

Extended Membrane Lifespan and Cost Savings: Greater mechanical strength and resistance to degradation increase the membrane's operational life. Lower frequency of membrane replacement reduces overall operational and maintenance costs.

Scalability and Versatile Implementation: The RGO membrane fabrication process is adaptable to large-scale production, making it viable for industrial water treatment plants. Can be integrated into existing FO systems with minimal modifications.

Water Treatment Industry: Improving efficiency and cost-effectiveness of desalination plants.

Renewable Energy Sector: Enabling carbon-negative energy applications via osmotic power generation.

Pharmaceutical and Chemical Processing: Enhancing chemical separation and purification processes.

Electronics and Sensor Technology: Potential applications in self-powered IoT devices and neuromorphic computing through osmotic battery integration.

In sum, the invention presents a breakthrough in FO membrane technology by developing RGO-based membranes with high selectivity, mechanical strength, chemical resistance, and potential for sustainable energy applications.

Without intent to limit the scope of the invention, exemplary embodiments of the present invention are given below.

In one embodiment, the FO membrane comprises a selectively permeable active layer formed of a graphene-based material with tunable interlayer spacing; and a support membrane providing mechanical stability; wherein the FO membrane enhances water flux while minimizing reverse solute flux.

In one embodiment, the support membrane is a polymeric support membrane comprising nylon, polyethersulfone (PES), mixed cellulose ester (MCE), cellulose acetate, and/or polycarbonate (PC) with a pore size ranging from 0.03 μm to 0.8 μm.

In one embodiment, the free interlayer spacing is less than 0.7 nm after water exposure.

In one embodiment, the graphene-based material comprises reduced graphene oxide (RGO). In one embodiment, the RGO active layer exhibits a reverse flux selectivity of at least 6700 L/mol when tested with a 1.5 M sodium sulfate draw solution.

In one embodiment, the RGO active layer is formed by thermally reducing graphene oxide (GO) sheets that are pre-treated with hydrogen peroxide oxidation and hydrothermal reactions to create nanoporous structures.

In one embodiment, the interlayer spacing of the RGO active layer is tunable by varying the annealing temperature between 150-190° C.

In one embodiment, the RGO active layer is adhered to the polymeric support membrane, providing enhanced mechanical stability as demonstrated by resistance to tape peel tests.

In one embodiment, the FO membrane exhibits resistance to chlorine degradation at concentrations exceeding 2 ppm and resistance to hexavalent chromium (Cr VI) oxidation.

In one embodiment, the FO membrane exhibits rejection rates exceeding 99.8% for salts and organic species in synthetic urine tests.

In one embodiment, the FO membrane demonstrates enhanced mechanical strength and chemical resistance against degradation by oxidizing agents.

In one embodiment, the FO membrane is used for selective chemical enrichment and desalination processes, separation and concentration of chemical species in industrial or environmental applications.

In one embodiment, the FO membrane is designed for long-term operational stability in high-salinity and wastewater treatment environments.

In one embodiment, the FO membrane is integrated into a hybrid desalination system in combination with ion exchange or reverse osmosis for improved brine management.

In one embodiment, the method for fabricating a FO membrane comprises synthesizing a graphene-based material; depositing the graphene-based material onto a support membrane; and treating the deposited material to enhance stability and selectivity.

In one embodiment, said synthesizing the graphene-based material comprises synthesizing graphene oxide (GO) sheets from natural graphite using an oxidation process; treating the GO sheets with hydrogen peroxide oxidation for 5-10 hours to create nanoporous structures; and subjecting the nanoporous GO sheets to hydrothermal reduction to obtain RGO suspensions.

In one embodiment, said depositing the graphene-based material comprises depositing the RGO suspensions onto a polymeric support membrane via vacuum filtration.

In one embodiment, said treating the deposited material comprises thermally annealing the deposited RGO membrane at a temperature of 150-190° C. to achieve a free interlayer spacing of less than 0.7 nm.

In one embodiment, the support membrane comprises nylon, PES, MCE, cellulose acetate, and/or PC with a pore size ranging from 0.03 to 0.8 μm.

In one embodiment, the method of further comprises an additional post-treatment step to enhance adhesion between the RGO layer and the support membrane, improving mechanical robustness.

In one embodiment, the forward osmosis system comprises an FO membrane as claimed above; a feed solution chamber containing wastewater or brackish water; and a draw solution chamber containing a high-salinity solution; wherein the FO membrane simultaneously enables water transport while minimizing reverse solute flux and allows for osmotic energy harvesting as electrical energy.

In one embodiment, the FO system further comprises electrodes positioned in the feed and draw solution chambers to capture osmotic energy as electrical output.

In one embodiment, the method for harvesting osmotic energy comprises utilizing a forward osmosis membrane as claimed in claim 1 to separate a high-salinity draw solution from a lower-salinity feed solution; allowing osmotic flow across the membrane to generate an ion flux; capturing the resulting electrochemical potential using electrodes to produce an open-circuit voltage; and converting the captured energy into usable electrical power.

In one embodiment, the draw solution comprises sodium sulfate or sodium chloride at concentrations of 1.0-2.0 M.

In one embodiment, the osmotic energy is stored as an electrochemical charge for use in low-power electronic devices, sensors, or IoT (Internet-of-Things) applications.

In one embodiment, the forward osmosis membrane-based osmotic battery comprises a stack of FO membranes as claimed in claim 1, arranged in a series-parallel configuration; alternating feed and draw solution compartments to maintain salinity gradients; and an electrical circuit to collect and regulate the generated osmotic energy.

In one embodiment, the FO membranes are printed using a gravure printing technique and thermally reduced in situ to produce large-area RGO membranes for scalable energy applications.

In one embodiment, the osmotic battery operates in an off-grid environment utilizing wastewater or brine as a feed solution to generate renewable energy.

In one embodiment, the method for producing large-area RGO FO membranes comprises depositing GO sheets onto a flexible substrate using a blade coating or gravure printing technique; thermally reducing the GO layer in situ using a controlled heat gun technique; and transferring the thermally reduced RGO membrane onto a polymeric support membrane for FO applications.

These and other aspects of the present invention are further described below. Without intent to limit the scope of the invention, exemplary instruments, apparatus, methods and their related results according to the embodiments of the present invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### Example

### Tuning Fabrication Factors for Reduced Graphene Oxide Forward Osmosis Membranes

Forward osmosis (FO) may serve as a near-zero energy approach for wastewater management and selective chemical enrichments with an appropriate FO membrane. There is a need for novel FO membranes with better physical stability and chemical compatibility with enhanced reverse flux selectivity. The current FO membranes such as cellulose triacetate (CTA, FTSH₂O) undergo physical degradation due to the mechanical damage by scaling under crossflow conditions. They may also suffer from the loss of membrane integrity when used with strong oxidants such as hexavalent chromium Cr (VI) due to possible chemical degradation by Cr (VI) oxidation. In addition, the CTA FO membranes are sensitive to chlorine (maximum chlorine 2 ppm as recommended by the manufacturer). Similarly, polyamide-based membranes are also hypersensitive to chlorine. In addition to better physical stability and chemical compatibility, the effects of reverse solute flux need to be considered. Using divalent draw solutes have a potential for the solutes to pass across the FO membrane and exceed saturation once combined with brackish groundwater or the seawater, leading to scaling on the active layer. On the other hand, there is substantial osmotic energy stored in the FO processes due to the high salinity difference between the feed solution and the draw solution. With improved mechanical strength and antifouling capability, the RGO membranes could be used for osmotic energy harvesting with further optimization, extending the useful lifetimes of the membrane-packed modules which is one of limiting factors in applications of reverse electrodialysis (RED) and pressure retarded osmosis (PRO). However, harvesting the osmotic energy while simultaneously concentrating waste brine has not been implemented in the FO processes, which warrants further investigation.

In this disclosure, we have systematically studied a variety of factors for fabricating thermally reduced graphene oxide (RGO) FO filtration membranes and have demonstrated that with a comparable water flux, the RGO membranes have an exceptionally large reverse flux selectivity with 1.5 M sodium sulfate draw solution, about 7 times larger than commercial cellulose triacetate membranes under the same testing condition. The interlayer spacing of the membranes can be fine-tuned by varying temperatures, so that the free interlayer spacing is less than 0.7 nm after exposed to water. The RGO-based membranes offer a few advantages with high reverse flux selectivity, mechanical robustness with strong adhesion to supporting nylon membranes without damage after FO tests and tape peel tests, and enhanced chromate and chlorine resistance. We have further demonstrated that in the FO processes, one can concentrate waste brine volume while simultaneously harvesting the osmotic energy as electricity, offering potential applications of forward osmosis-based osmotic batteries for powering electronic devices.

To overcome the swelling of the GO lamellar structure in the aqueous solution, various approaches have been developed, including partial reduction of GO to RGO by a variety of reductants and thermal treatments, production of GO by electrochemical oxidation of graphite, confinement of GO lamellar structure in a polymer matrix or zeolitic imidazolate framework-8, ionic control of GO interlayer spacing, and liquid electrolyte mediation of chemically reduced graphene oxide. However, RGO-based FO membranes with high performance to address above mentioned challenges have not been reported. A common method to prepare GO membranes is vacuum deposition by using filter membranes. Further thermal reduction of GO membranes to RGO membranes is an attractive approach because the interlayer spacing is tunable by varying annealing temperatures. Additionally, there is keen interest in exploiting the merits of GO and other 2D emerging materials in conjunction with state-of-the-art polymeric membranes. However, a systematical study on the optimal membrane synthesis conditions is still lacking, limiting the revelation of superior RGO-based FO membranes.

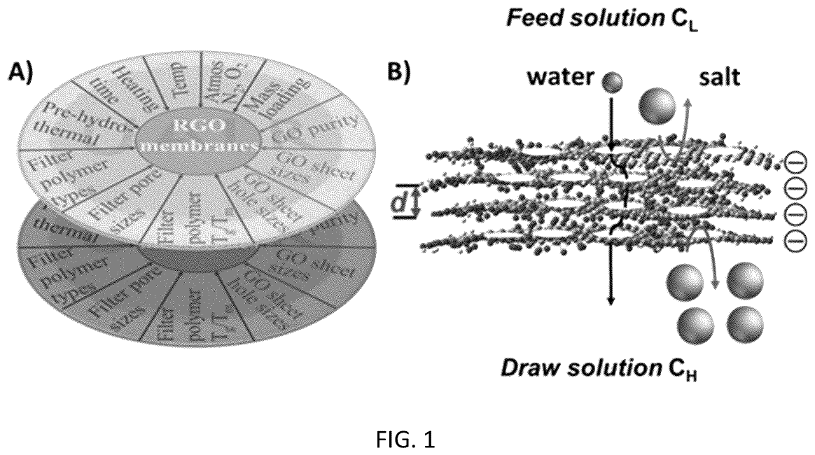

The exemplary embodiments of the invention demonstrate that thermal reduction in combination with polymer adhesion is an effective approach to make stable RGO-based FO membranes with superior FO performance to commercial FO membranes. RGO membranes are prepared through a comprehensive approach by optimizing various factors as summarized in FIG. 1, leading to a series of outstanding RGO membranes. These factors include 1) Filter polymer membranes. Considering factors include polymer types, pore sizes, and polymer glass transition temperature T_{g} or melting temperature Tₘ (Table 1); 2) GO sheets. Factors in consideration include GO purity, sheet sizes, sheet hole sizes, and functional groups and densities on sheets; and 3) Treatment conditions: a variety of factors considered includes pre-hydrothermal treatment of GO, thermal annealing of RGO membranes, annealing temperatures, annealing atmospheres, and GO/RGO mass loadings. The right combination of the optimized RGO and an appropriate filter membrane under an optimized thermal annealing condition produces superior FO membranes with robust mechanical and chemical stability. The adhesion of RGO in the filter polymer and the reduction of RGO interlayer spacing are accomplished simultaneously under the right thermal annealing condition. In this approach, GO is first reacted with oxidants such as H₂O₂ to produce porous GO sheets in different sizes, one of the important factors to enhance water flux. The resulting GO is then used for hydrothermal reaction to produce RGO aqueous suspensions, the other important factor to shorten the membrane preparation time and enhance the final membrane's stability and FO performance. Membranes with different RGO mass loadings (different thicknesses) are prepared using vacuum filtration on a variety of filter membranes with pore sizes in a range from 0.03 to 0.8 μm. The resulting RGO membranes are heated at temperatures above 70° C. for 0-4 hours in air or under an inert atmosphere such as N₂. By systematically optimizing these conditions, Superior RGO-based FO membranes are obtained in the exemplary study. The best FO filtration performance is achieved with an exceptionally large reverse flux selectivity 7550 L/mol with 1.5 M Na₂SO₄ draw solution, over 7.5 times larger than commercial FO membrane cellulose triacetate (CTA). The membranes also rejected salts and organic species in an ersatz urine (pH 7.28) with rejection rates >99.8%, and in an ersatz flushed urine (pH 2.16) with rejection rates >99.3%, better than CTA. The RGO membranes were also highly stable during and after the filtration tests.

TABLE 1
Glass transition temperature (T_{g}), melting temperature (Tₘ),
and heat deflection temperature (HDT) of selected polymers and
corresponding filter membrane maximum operating temperature.

| | | Tₘ | Membrane maximum |
|---|---|---|---|
| | T_{g} | (HDT) | operating temperature |
| Polymer | (° C.) | (° C.) | (° C.) Ref. [76] |
| Isopore | 140-150 | — | 140 |
| Polycarbonate (PC) | | | |
| Mixed cellulose | 130 | — | 130 |
| ester (MCE) | | | |
| Polyethersulfone | 220-230 | (204) | 130/180* |
| (PES) | | | |
| Nylon 6,6 | 50-60 | 240-265 | 180 |
| | Ref. [77, 80] | Ref. [77, 80] | |
| Cellulose acetate | 200-247 | 229-294 | 135 |
| | Ref. [81] | Ref. [81] | |

### Experimental Work

Preparation of GO/RGO Suspensions. GO was prepared using Tour method from natural graphite. GO suspension with a concentration around 2.0 mg/mL was obtained after a series of centrifugation, purification, and dialysis processes. To make nanoporous GO, The GO suspension was further treated with the following procedure: Briefly, 100-200 mL of GO suspension were centrifuged at 10,000 rpm. The top clear solution was removed. The precipitate was reacted with 30 wt % H₂O₂ at a temperature at ˜70° C. for 5-15 hours to produce porous GO sheets in different sizes. The resulting GO was further purified with several wash-centrifuge cycles to remove impurities of salts and small oxidative fragments, and then used for hydrothermal reactions at 110-140° C. for 2 hours to produce RGO aqueous suspensions (RGO-HY, where RGO-HY stands for hydrothermally reduced RGO).

Preparation of GO and RGO Membranes. GO and RGO suspensions, with GO and RGO of 0-10 mg (depending on the sizes of filter membranes and the thicknesses of GO and RGO membranes), were then used to prepare GO and RGO membranes via vacuum filtration on various filter membranes (typical diameter of 47 mm with an active area of 10.2 cm²). The filter membranes included isopore polycarbonate (PC) membranes, mixed cellulose ester (MCE) membranes, polyethersulfone (PES) membranes, nylon membranes, and cellulose acetate membranes (Table 1), with pore sizes from 0.03 to 0.8 μm, purchased from Thermo Fisher Scientific and Sterlitech, respectively. The resulting GO and RGO membranes were allowed to dry, then heated at 70-230° C. for 0-4 hours in an oven (VWR Gravity Convection oven 414004) under the air atmosphere or under a nitrogen atmosphere in a tube furnace (Lindberg/Blue HTF55342C) where a flow meter (OMEGA) was used to control the nitrogen gas flow through the furnace, resulting in RGO-HA, where RGO-HA references to thermally annealed RGO-HY. For structure characterization after thermal annealing, GO or RGO-HY membranes were prepared with a mass loading ˜5-15 mg on isopore PC filters under vacuum filtration. After a membrane was allowed to dry, it was peeled off from the filter to obtain a free-standing membrane. The membrane was then divided into four pieces. One piece was not thermally annealed, and the other three pieces were thermally annealed at 150, 170 and 190 or 230° C., respectively.

Characterization of GO and RGO Nanosheets and RGO Membranes. The thermogravimetric analysis (TGA) (Mettler Toledo TGA/DSC) was used to analyze the thermal properties of the samples. All measurements were carried out over a temperature range of 25-850° C. Both GO and RGO's morphology, microstructure, and cross-section images were measured using scanning electron microscopy (SEM) (Scios 2 Dual Beam SEM/FIB), operating at 5 keV/50 pA, with energy-dispersive X-ray (EDX) analysis of the compositions. The structures of as-prepared GO and RGO sheets before and after H₂O₂ treatments were measured with Talos L120C transmission electron microscopy (TEM) operating at 120 kV by dropcasting the suspensions onto a lacey carbon TEM grid to support the GO and RGO sheets. X-ray photoelectron spectroscopy (XPS) (Thermo Scientific K-Alpha) was performed for the compositions and structures of the GO and RGO samples. The FT-IR (Thermo Scientific NICOLET 6700) analysis on transmission or reflection modes was carried out to examine the changes of GO/RGO's characteristic absorption bands before and after various treatments. For X-ray diffraction (XRD) measurements (Rigaku MiniFlex 600), the changes of 2θ angles and interlayer distances were measured for a step size of 0.02 and dwell time of 5°/min in the 2θ range of 3°-80° under the condition of 40 KV, 15 mA, and Cu (Kα) target.

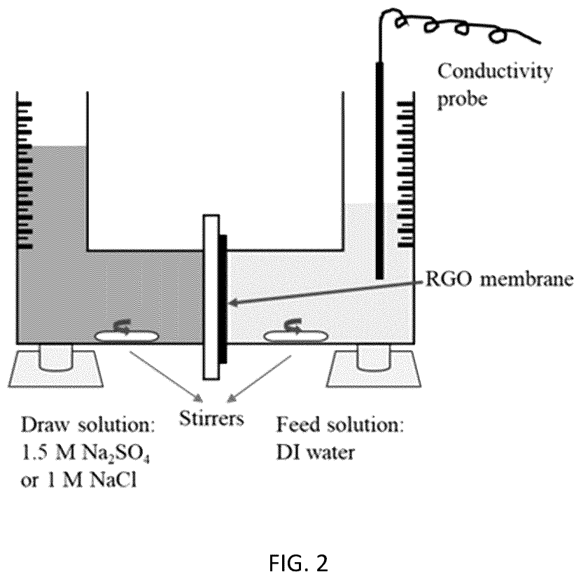

FO Tests. The FO tests were performed in the customized H-cells (Pine Research Instrumentation), similar to that described in Elimelech's work. The FO test setup was schematically shown in FIG. 2. The active layer facing feed solution (AL-FS) mode was used. The effective area of the membranes in FO tests was 8.0 cm². Each half cell had a volume of 50 mL. The volume changes were measured using the pre-calibrated scales as shown on the H-cell. The volume decrease in the feed solution (FS) matched the volume increase in the draw solution (DS), as measured experimentally for Na₂SO₄ and calculated for NaCl based on DS solution density information, which yielded a volume difference <0.003 mL per mL water permeated. This difference was insignificant. Therefore, the volume change in DS was recorded. In a typical FO test, the initial volume was 30 mL for DS and 40 mL for FS, resulting in a 2.2 cm difference in height between FS and DS. This height difference gave a pressure ˜0.0022 bar, calculated with P=1.01325 bar×(h_{H2O}× d_{H2O})/(h_{Hg}×d_{Hg}), where h_{H2O}=2.2 cm, d_{H2O}=1.0 g/mL, h_{Hg}=76 cm, and d_{Hg}=13.5 g/mL. This value was negligible as compared to the osmosis pressure of 1.5 M Na₂SO₄ draw solution (˜104 bar) or 1 M NaCl draw solution (˜46 bar) estimated with osmosis pressure Π=iCRT, where i is the van't Hoff factor, C is the molar concentration of a draw solution, R is the gas constant, and T is the absolute temperature (assuming i=2.80 for Na₂SO₄ and 1.85 for NaCl, respectively). Those values are close to ˜107 bar extrapolated from literature values for 1.5 M Na₂SO₄, and 47.3 bar or 41.86 bar for 1 M NaCl, respectively. Therefore, the height changes in FS and DS during the FO test have a negligible impact on the results.

All membranes were wet in DI water for 30 min before FO tests. In reference to Elimelech group's work, Na₂SO₄ solutions of 0.5, 1.0, 1.5 M or 0.5, 1, and 2 M NaCl were used as a draw solution and DI water was used as a feed solution, in order to evaluate the membrane performance in FO. FO tests were conducted for 2 hours. The electrical conductivity changes of feed solution were monitored with an electrical conductivity meter (Sper Scientific benchtop meter) over the period of the FO test. The conductivity was converted to salt concentration in feed solution based on a conductivity-concentration standard curve established for each salt used. Water flux (J_{w}), reverse draw salt flux (Jₛ), and reverse flux selectivity (J_{w}/Jₛ) were calculated, based on equations J_{w}=ΔV/(A×Δt) and Jₛ=[ΔC×(V₀−ΔV))/(A×Δt)], where ΔV is the volume change of the draw solution (L), A is the effective filtration area (m²), At is the filtration time (h), ΔC is the concentration change of draw solute presented in feed solution (mol/L), and V₀ is the starting volume of feed solution. The reverse flux selectivity is determined exclusively based on the selectivity of the active layer and is a ratio of water flux to reverse salt flux. For comparison of FO performance among different membranes, those values at 30 min FO testing time were used. Commercial FTSH₂O CTA FO membranes were purchased from Sterlitech, tested under identical FO test conditions for comparison.

It is realized that Jₛ, J_{w} and J_{w}/Jₛ are not intrinsic properties of the membrane, because these quantities depend on the concentration and osmotic pressure of the draw and feed solutions, the type and diffusivity of the solutes, and the hydrodynamic conditions at the membrane interface. For these reasons, the identical operating conditions have been used in this work in order to compare the FO performance of fabricated RGO membranes and CTA membranes. In addition, it should be noted that the conductivity data might not be reliable when they are used for salt concentration determination in situations involving viscous solutions like sucrose used as a draw solution in literature. The standard curve established under the salt-water condition cannot be applied to the salt-sucrose-water condition, because the latter condition has higher viscosity than the former condition. This results in a lower conductivity value for the same amount salt in the sucrose solution which underestimates the salt concentration if the standard curve established under the salt-water condition is used, leading to a false high salt rejection rate. The conductivity standard curve under a given sucrose concentration must be established for salt concentration determination or other chemical analysis methods such as inductively coupled plasma (ICP)-mass spectrometry and ion chromatography can be used to determine salt concentrations under the salt-sucrose-water condition.

Tape Peel Tests. The mechanical robustness of the RGO membranes was tested with a tape peel test. The test was based on the ASTM D3359 and conducted by pressing a piece of adhesive tape onto the surface of a RGO membrane, removing the tape, and then inspecting the membrane visually. A following-up FO test on the membrane with 1.5 M Na₂SO₄ draw solution and DI water as a feed solution was carried out to examine whether the membrane retained its FO performance after the tape peel test, in comparison with the RGO membrane without undergoing the tape peel test. Six RGO membranes were used, three of them served as a control without the tape peel tests and the other three underwent the tests.

Osmotic Energy Measurements. For osmotic energy studies, two Ag/AgCl electrodes (CH Instruments) or two carbon cloth (PW03, Zoltek) electrodes were placed in the feed and draw solutions, respectively. Open-circuit voltage (OCV) was monitored using an ohmmeter during the FO process.

### Results and Discussion

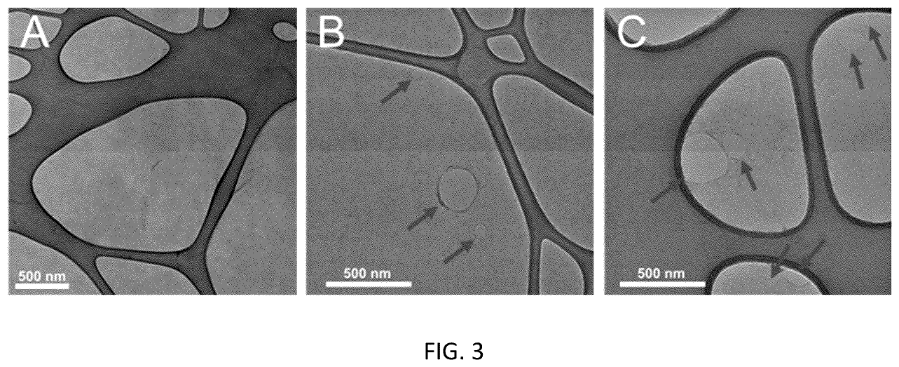

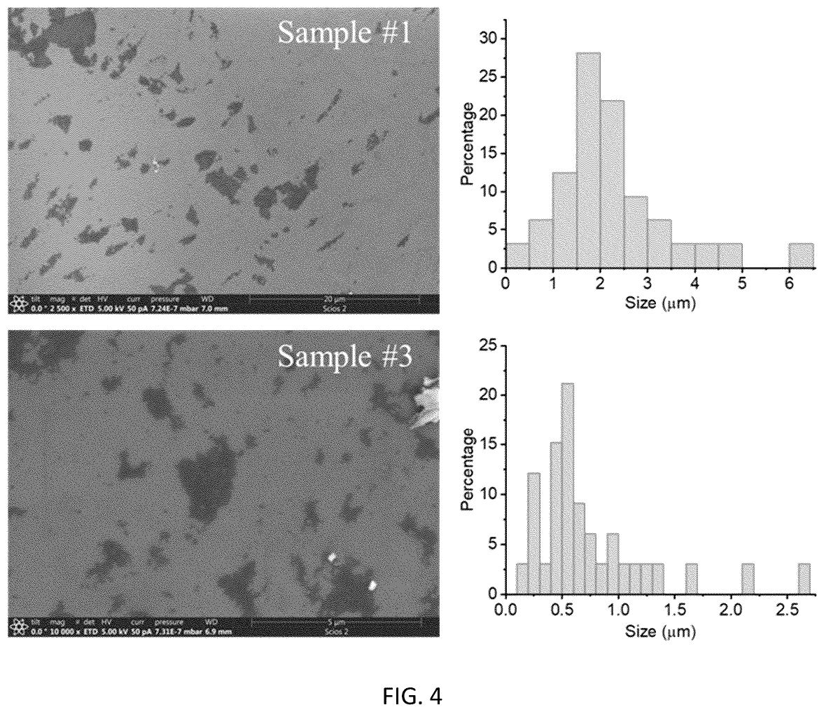

Synthesis and Characterization of Porous GO Sheets Treated with H₂O₂ Oxidation. GO was synthesized by the Tour method. The GO was further treated with 30 wt % H₂O₂ for 0-15 hours to produce porous GO sheets in different sizes. The resulting GO suspensions were then used for hydrothermal reaction to produce RGO aqueous suspensions. To prepare the GO and RGO sheets for characterization by TEM, the suspensions were dropcast onto a lacey carbon substrate which acted as a support. As shown in the TEM images (FIG. 3), no holes on the pristine GO (Sample #1) single sheets are observed before the H₂O₂ treatment. However, after 5-hour H₂O₂ treatment, holes in the range of 50-100 nm diameter are observed on the GO and RGO single sheets in the GO (Sample #2) and RGO (Sample #3). As schematically shown in FIG. 1, B, the holes basically provide a shortcut for water passing through, while ions and molecules are blocked by the narrow interlayer spacing-based size exclusion and electrostatic repulsion for the anions. The H₂O₂ treatment also reduced the GO and RGO sheet sizes from an average 2.2 μm of Sample #1 to an average 0.77 μm of Sample #3 (FIG. 4).

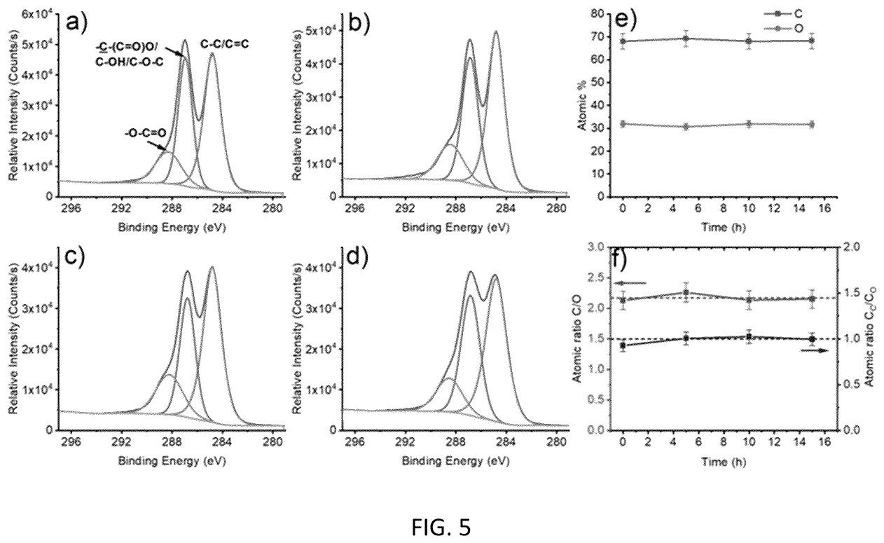

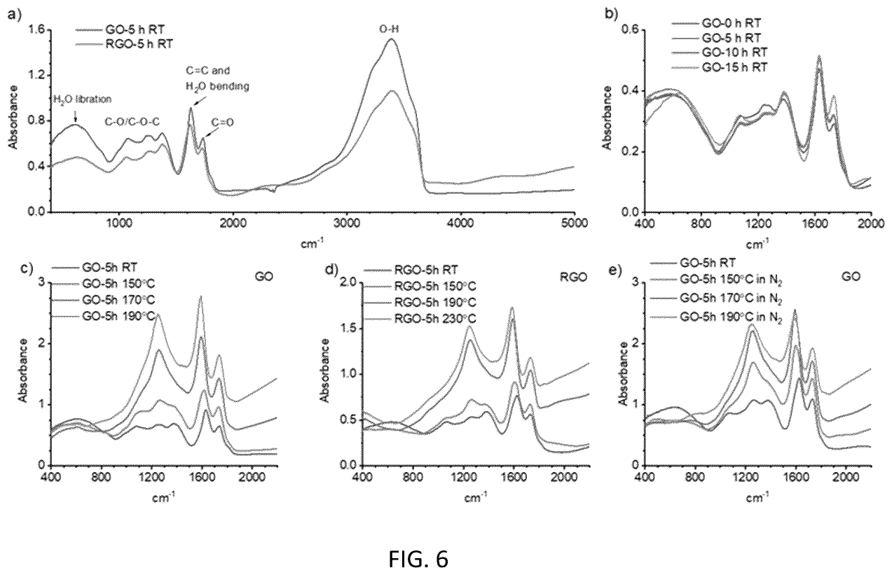

The compositions of the GO after H₂O₂ treatments were further analyzed by XPS. In FIG. 5, the XPS analysis of carbon 1s (C1s) spectra reveals the dominant C—C and C═C of graphene lattices (˜284.8 eV), hydroxyl C—OH (˜286 eV), and ester C(═O)O (˜289 eV). Interestingly, the atomic percentage remains at about 68% for C atoms and 32% for O atoms, respectively, regardless of the treatment times (FIG. 5, e). The average atomic ratio is ˜2.2 for C/O and ˜1 for C_{C}/C_{O}, respectively, where C_{C} and C_{O} stand for C—C/C═C carbon and oxygenated carbon, respectively (FIG. 5, f). This results in the atomic ratio C_{C}:C_{O}:O≈1.1:1.1:1 in the pristine and nanoporous GO samples. The result contradicts the intuition that with longer oxidation times, the oxygenated carbon ratio should be increased. However, since the GO suspension and the resulting porous GO suspensions were purified through multiple sonication-centrifuge washing cycles until the conductivity of the supernatant reached a minimal value, the small oxidative fragments, which may contain more C_{O} carbons, were eliminated significantly, in addition to other impurities like residual salts. The infrared (IR) spectra (FIG. 6, b) show the same absorption features with nearly equal absorbance under different treatment times, consistent with the XPS results. We have also observed that the H₂O₂ treatment is important to enhance water flux, as will be discussed in the FO test section.

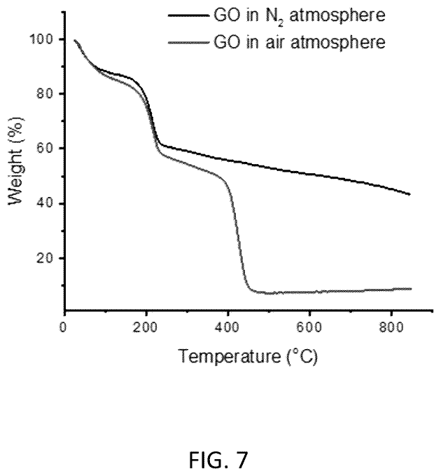

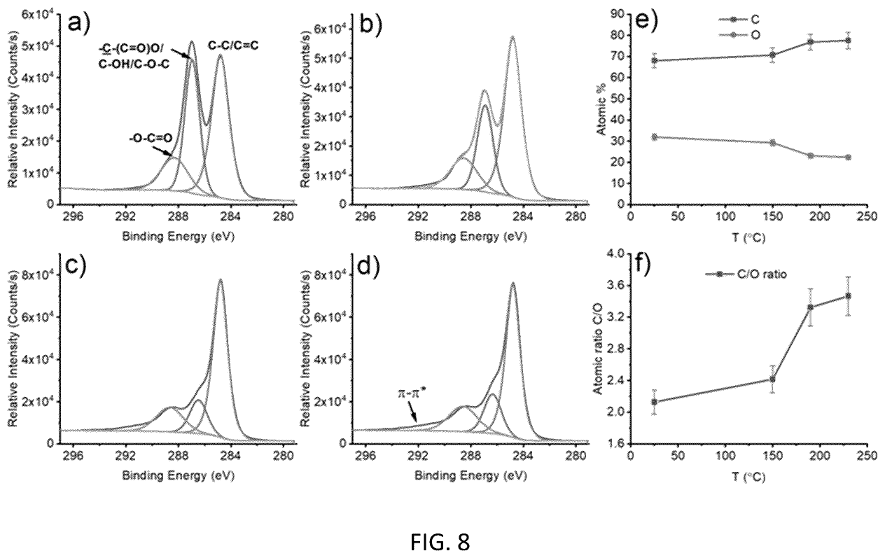

GO and RGO Membranes Annealed at Different Temperatures. For structure characterization, free-standing GO and RGO membranes were prepared via vacuum filtration, as described in the Methods section. The TGA curves of GO samples in air and nitrogen atmospheres in FIG. 7 show that the GO samples under both atmospheres have a similar mass loss (˜40%) at temperatures below 240° C. The mass loss can be related to the loss of functional groups and water molecules. The mass of the GO sample under the N₂ atmosphere decreases slightly as the temperature increases further (˜56% mass loss). In comparison, the sample in the air atmosphere has a significant mass loss (˜90%) at temperatures above 400° C. The result suggests that heating GO samples at temperatures≤240° C. should be considered for both atmospheres. The IR spectra in FIG. 6 show similar absorption features of the annealed GO samples in both nitrogen and air atmospheres at different annealing temperatures (FIGS. 6c, e). Therefore, we focus on GO samples annealed in air. For XPS analysis, a series of GO membranes were treated at 150, 190, and 230° C., respectively. The C1s XPS spectra in FIGS. 8a-d show a gradual increase of the C_{C} peak at 285 eV and a decrease of C_{O} peaks mainly at ˜286 eV with the temperature. This suggests an increase in the amount of sp² hybridized carbon and a decrease in the sp³ carbon of oxygenated groups like hydroxyl C—OH (˜286 eV). The oxygen content is 32% in pristine GO and decreases to 22% after annealing at 230° C. The C/O ratio is 2.1 for the GO before thermal annealing and increases to 3.5 after annealing at 230° C. (FIG. 8, f). The π-π* shake-up satellite peak is also observed around ˜292 eV in the annealed samples, further indicating that the delocalized π conjugation, a characteristic of aromatic C structure, has been partially restored in the samples after thermal annealing. The result is further supported by the IR spectra in FIG. 6, c-e where the background absorption increases with the annealing temperature, indicating the partial restoration of π conjugation.

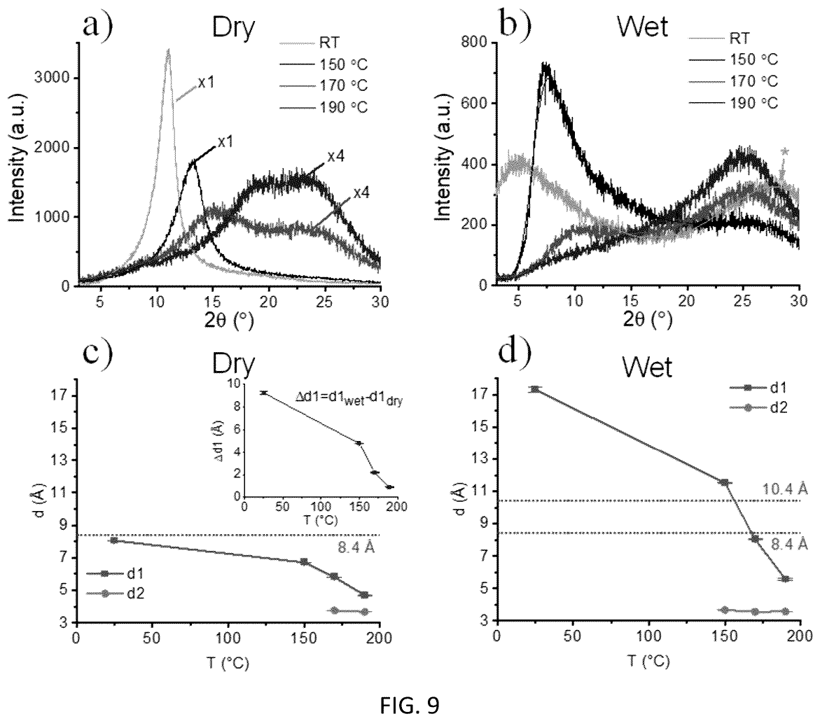

XRD was used to characterize the membranes annealed at temperatures from 150 to 190° C. The results in FIGS. 9a, c show a clear decrease in interlayer spacings. This change can be correlated with the removal of oxygenated functional groups. When the membranes are saturated with water (FIG. 9, b,d), there is an increase in the corresponding interlayer spacings, as compared with the dry membranes (FIG. 9, a, c). In FIG. 9, c and FIG. 5, d, the interlayer distance d₁ is related to the region with functional groups and d₂ is related to the restored sp² network. d₂ has a value of about 0.37 nm in the dry forms and 0.36 nm in the wet forms. Both values are larger than 0.34 nm of the graphite interlayer spacing. The percentage of the d₂ component increases with the annealing temperature and it becomes dominant at 190° C. For the water-saturated pristine GO sample, there is a peak marked with an asterisk in FIG. 5, b, which has an interlayer spacing of 0.32 nm, less than graphite interlayer spacing 0.34 nm. This peak is not present in the dry form. Therefore, its origin is not related to GO. It could come from the background contribution of protection thin polymer film used to prevent the wetted membranes from drying during XRD measurements. However, the background (not shown) does not match well with the peak marked with the asterisk. Further research is needed to identify its origin. In comparison of FIG. 9, c with FIG. 9, d, the interlayer spacing increase is significant in the wet membrane without thermal treatment, by 0.93 nm. While the extent of the swelling is decreased with the annealing temperature, by 0.48 nm for the membrane annealed at 150° C., 0.22 nm at 170° C., and 0.09 nm at 190° C., respectively (the insert in FIG. 9, c). The swelling of the membranes in the aqueous solutions is caused by the hydrophilic functional groups in GO, responsible for low rejection properties of GO-related membranes. The thermal treatment resulted in restoration of sp² carbon which leads to a more stable laminated stacking network through the π-π stacking against the membrane swelling in water. For water purification, an interlayer spacing between 0.84-1.04 nm has a free spacing between 0.50-0.70 nm after subtracting 0.34 nm of one layer graphene thickness, which allows water passing through while blocking many ions and molecules with sizes >0.7 nm such as Na⁺ ions (0.716 nm in diameter), based on size exclusion. As shown in FIG. 5, d, after saturated with water, the di spacing (0.84≤d₁≤1.04 nm) is at a narrow temperature range between 155 and 170° C., suggesting a preferential temperature range for thermal treatment of GO membranes so that the required interlayer spacing can be made to block small ions like Na⁺ ions. Since the laminar structure and interlayer spacing of fabricated GO membranes could be affected by the structural features of the used filter membrane such as the pore size and surface roughness, the above result only provides a guidance for selecting a temperature range for GO membrane thermal annealing.

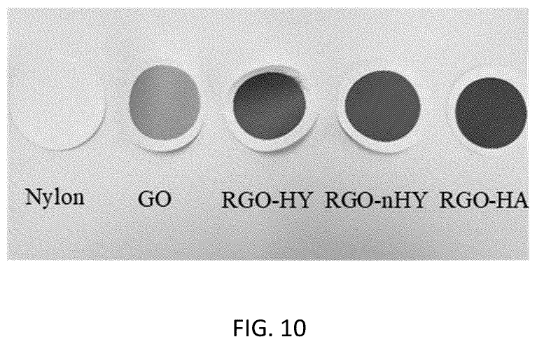

GO and RGO membranes on a variety of filter membranes and under different treatment conditions have been prepared. Here we focus on RGO membranes prepared on nylon filter membranes since nylon filter membranes have a maximum operating temperature of 180° C. (Table 1), matching well with the thermal annealing temperature range determined from the XRD results. FIG. 10 shows a typical set of GO and RGO membranes prepared on nylon filter membranes including hydrothermally reduced RGO (RGO-HY), thermally annealed RGO-HY (RGO-HA), and thermally annealed GO without hydrothermal pretreatment (RGO-nHY).

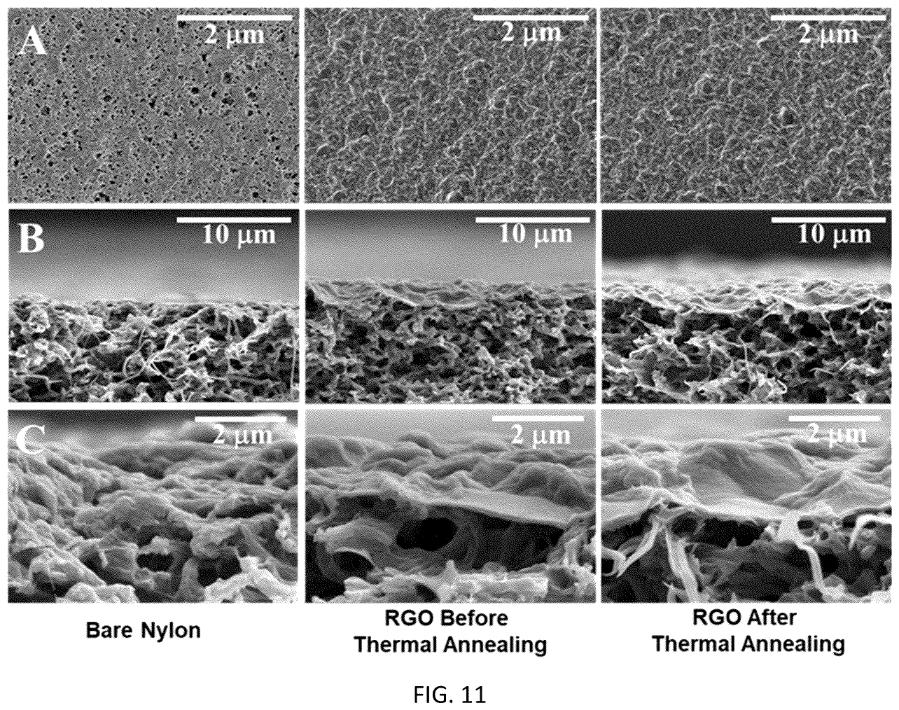

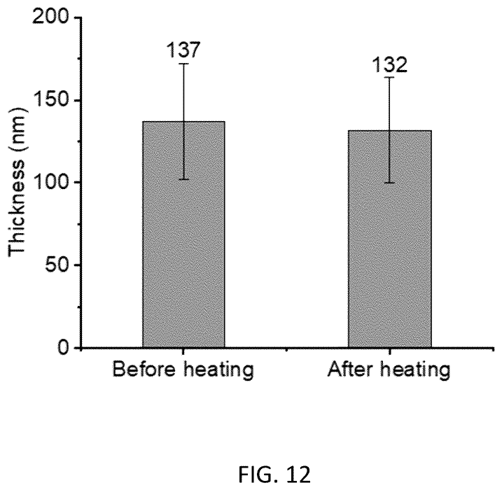

The surface morphologies and cross-sections of a bare nylon membrane and representative RGO membranes on nylon filter membranes before and after thermal annealing at 155° C. were measured with SEM. The SEM images in FIG. 11 show that the RGO membranes cover the nylon membrane porous surfaces conformally. The average thickness of the RGO membrane is 137 nm before heat annealing and 132 nm after thermal annealing, respectively, as shown in FIG. 12. The measured thickness agrees with the calculated 136 nm based on density 1.8 g/cm³ for GO or 128 nm based on density 1.91 g/cm³ for RGO (GO/RGO mass 0.25 mg and a membrane area of 10.2 cm²). As previously studied, GO and RGO nanosheets may favor the formation of the conformal morphologies of coatings on filter membranes. The large contact areas may enable strong interfacial van der Waals interactions, leading to the enhanced GO and RGO adhesion to the filter membranes. We have also observed that the filter membrane area covered with RGO is mechanically stronger than that without RGO coverage after thermal annealing, suggesting that there might be additional bonding formations between RGO and nylon membranes. Further research is needed in order to reveal the details of the mechanisms.

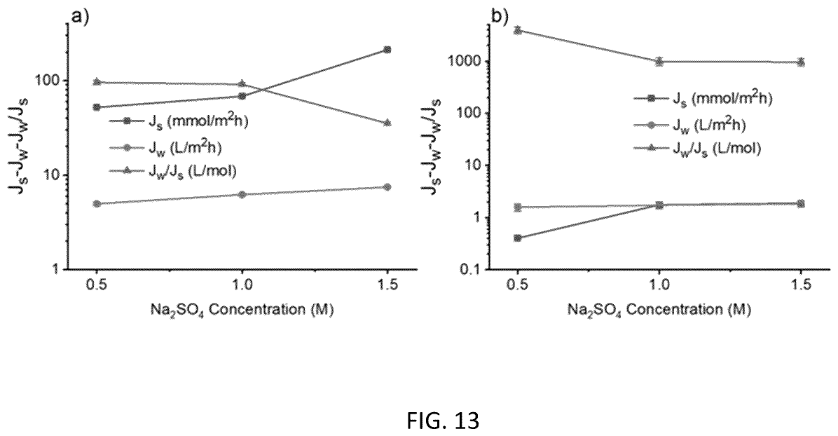

FO Tests on RGO Membranes in Comparison with CTA Membranes. The FO tests were conducted with a stationary H-cell (FIG. 2), similar to that described in literature. Deionized (DI) water was used as a feed solution and Na₂SO₄ and NaCl solutions of different concentrations were used as draw solutions. The data at the 30 min FO test were used for analysis. We tested a series of RGO membranes which were treated under various conditions as summarized in FIG. 1. Those conditions include different types of filter membranes, different hydrogen peroxide oxidation times, treatments with and without hydrothermal reactions, different filter membrane pore sizes, etc. Some of the results are presented in FIGS. 13-17. The key consideration is to minimize the reverse flux of draw solute from the draw solution into the feed solution without affecting the water permeability at a high reverse flux selectivity. Different draw solution concentrations of 0.5, 1.0, 1.5 M for Na₂SO₄ and 0.5, 1.0 and 2.0 M for NaCl were tested first. Based on the diameters of ions and anion charges (0.716 nm for Na⁺, 0.758 nm for SO₄²⁻, and 0.664 nm for Cl⁻), it is expected that the RGO membranes reject Na₂SO₄ better than NaCl.

FIG. 13, (a) shows the result of the RGO membrane on the 0.1 μm isopore PC membrane with Na₂SO₄ draw solutions. The higher concentration of the draw solution leads to higher reverse salt flux Jₛ. So does the water flux J_{w}. These behaviors are expected as the draw concentration increases. However, the reverse flux selectivity is less than 100 L/mol, much smaller than those with a 0.2 μm isopore PC filter membrane (FIG. 13, b). In FIG. 13, b, the values of the reverse flux selectivity J_{w}/Jₛ at different draw solution concentrations are larger (>800 L/mol). However, the water flux is relatively low, less than 2 L/m²h, suggesting that other filter membranes should be considered for tests. To screen the membrane samples with the best FO performance, we focused on 1.5 M Na₂SO₄ and 1.0 M NaCl draw solutions for the FO tests.

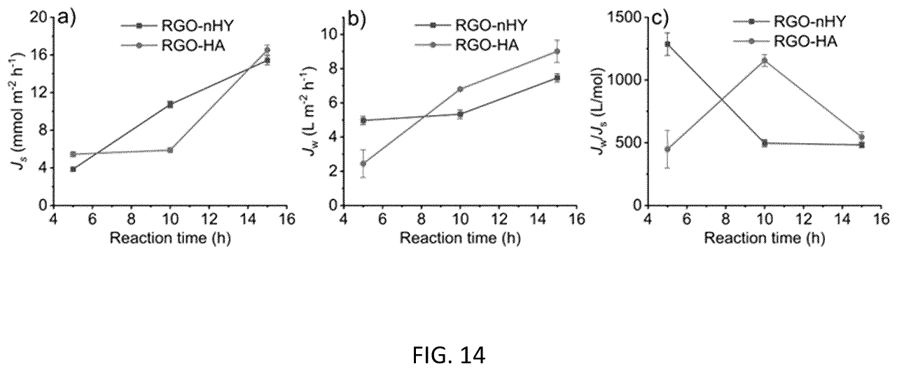

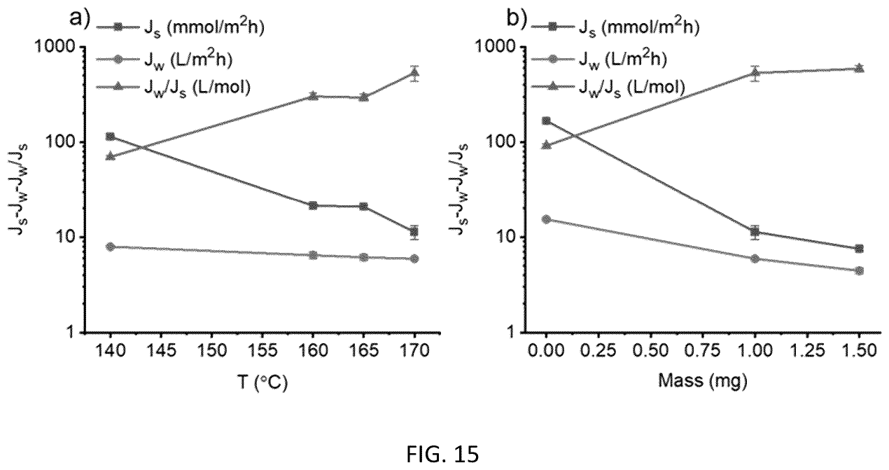

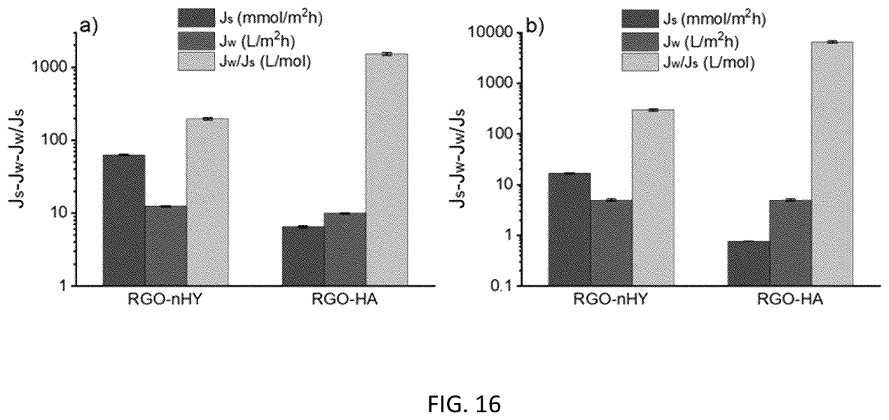

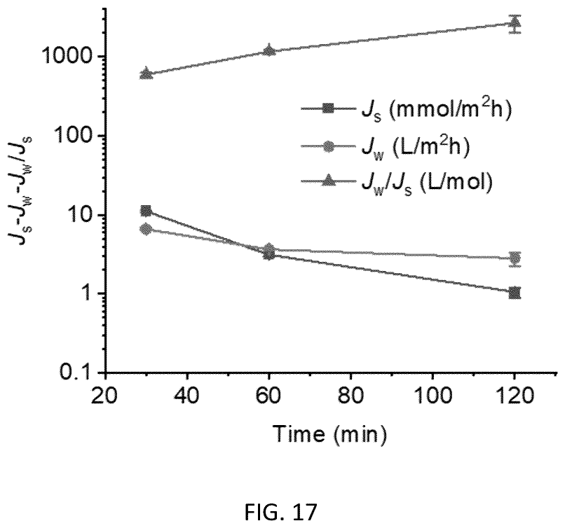

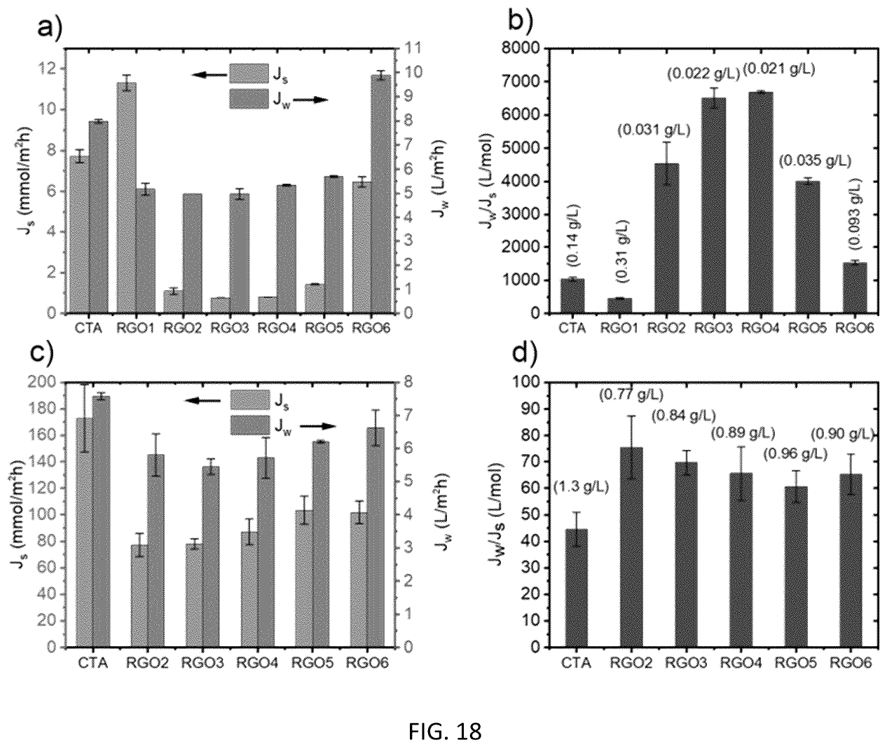

Under different treatment times with hydrogen peroxide, both J_{w} and Jₛ of RGO membranes on PES filter membranes increase with the reaction time. However, J_{w}/Jₛ is maximized at 5 h oxidation time with a value of ˜1300 L/mol for RGO without hydrothermal pretreatment (RGO-nHY) and 10 h oxidation time with a value of ˜1200 L/mol for RGO with hydrothermal pretreatment (RGO-HA) (FIG. 14). The reverse flux selectivity values of both RGO membranes are comparable to those of the commercial CTA membranes under the same FO test condition as to be shown in FIG. 18. However, RGO membranes on both PC and PES membranes were not mechanically strong and were damaged on the areas in contact with O-rings after FO tests. Therefore, we turned our attention to nylon filter membranes. With different filter membrane pore sizes, the FO performance is also different as shown in FIGS. 15-16 where 0.2 and 0.45 μm pore nylon filter membranes were used. We first tested 0.2 μm pore nylon filter membranes using RGO treated with 10 h oxidation time. As seen in FIG. 15, increasing the annealing temperature or mass loading lead to an increase in the reverse flux selectivity, but the increase is still not significant as compared to FIG. 14, c. Therefore, in the next step we investigated the FO performance on 0.45 μm filter. As a result of the increase in filter pore size, the porous RGO nanosheets made from the 10 h reaction could not be fabricated on the 0.45 μm nylon due to their sheet sizes less than 0.45 μm, resulting in passing through the filter membrane. Therefore, porous GO and RGO prepared from 5 h oxidation time were used to prepare RGO membranes of different mass loadings. As shown in FIG. 16 where 0.45 μm nylon filter membranes were presented, RGO membranes on 0.45 μm nylon filter membranes show a gigantic improvement in FO performance. Therefore, we further focused on the 0.45 μm nylon filter membranes by fine tuning the conditions. On nylon filter membranes, the FO performance of the membranes with RGO treated with hydrothermal reactions (RGO-HA) is enhanced significantly as compared to those without hydrothermal reactions (RGO-nHY). As seen in FIG. 16, the RGO-HA membranes both at 150° C. and 170° C. have reverse salt flux values lower than those of the RGO-nHY membranes but with much higher reverse flux selectivity values. This suggests the importance of the hydrothermal reaction to improve the performance of RGO membranes. The water flux values for both membranes are also high (˜10 L/m²h) at 150° C., which are close to the literature values of a thin nanocomposite membrane with vertically aligned GO nanosheets under the same stationary FO test condition with 1.5 M Na₂SO₄ draw solution (˜10 L/m²h). The reverse flux selectivity of the RGO-HA membranes at 170° C. is significantly higher (6500 L/mol) than that of the RGO-nHY (FIG. 16, b). For the thermal annealing time, it was chosen at 2 hours as the time-dependent result suggested in FIG. 17.

We compared the FO performance of the RGO membranes with a commercial FTSH₂O CTA FO membrane using 1.5 M Na₂SO₄ draw solution. As shown in FIG. 18, a, b, the RGO membranes have exceptionally high reverse flux selectivity, with the highest J_{w}/Jₛ of 6700 L/mol (RGO4), superior to 1000 L/mol of CTA measured under the same FO test condition. The water flux J_{w} of the RGO4 membrane is 5.3 L/m²h, a little bit less than 8.0 L/m²h of CTA. In FIGS. 18a, b, it is further demonstrated that by adjusting treatment conditions, the RGO membrane (RGO6) can reach to J_{w}-9.9 L/m²h while maintaining a relatively high reverse flux selectivity of 1500 L/mol, both superior to those of CTA (J_{w}=8.0 L/m²h and J_{w}/Jₛ=1000 L/mol).

In comparison of RGO6 (annealed at 150° C.) with RGO4 (annealed at 160° C.), RGO6 has a higher J_{w}. It can be due to its larger free interlayer spacing (FIG. 9, c, d) which provides sufficient pathways for the water flow. RGO6 is also more hydrophilic than RGO4 as it contains more hydrophilic functional groups as shown in FIG. 8 where a decrease in the sp³ carbon of oxygenated groups like hydroxyl C—OH and an increase in the amount of sp² hybridized carbon occur with the increase of the annealing temperature. Both factors lead to higher water permeation for RGO6. On the other hand, its larger free interlayer spacing also leads to a higher Jₛ as shown in FIG. 18, a. A similar result was reported by Jang et al. on the FO performance of graphene oxide nanocomposite membranes using the support of mixed cellulose ester membranes.

Similarly, the RGO membranes are also superior to CTA membranes when 1.0 M NaCl draw solution is used (FIGS. 18c, d). The J_{w}/Jₛ of RGO2 membrane is 75 L/mol, 1.7 times larger than that of CTA (45 L/mol). Its J_{w} is 5.8 L/m²h, a little bit less than 7.6 L/m²h of CTA.

In order to fully describe membrane systems and compare with literature values, future work will be performed to determine three intrinsic parameters of the superior RGO membranes, the pure water permeability coefficient, A, the solute permeability coefficient, B, describing the transport across the membrane active layer, and the structural parameter, S, quantifying the mass transport length scale across the membrane support layer.

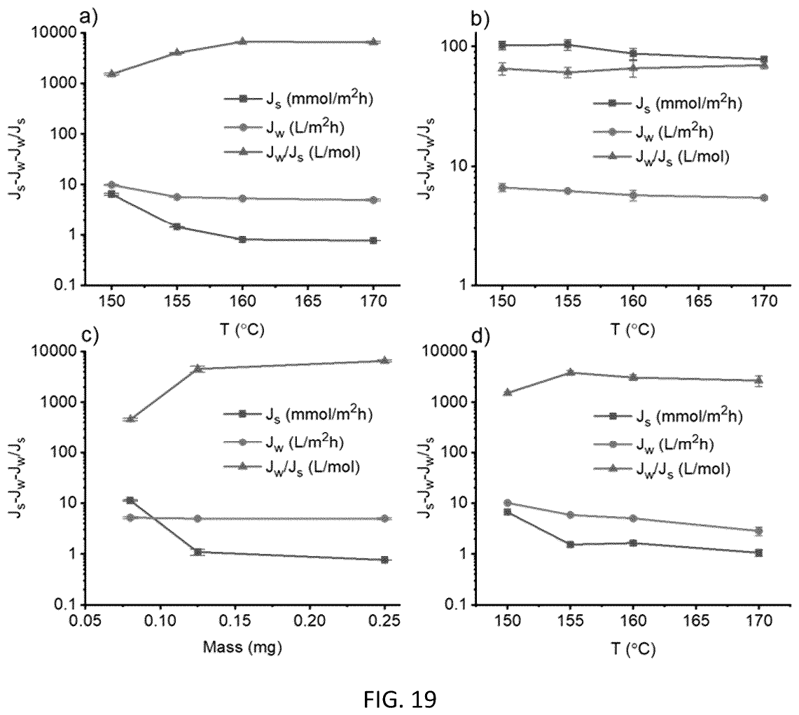

FIGS. 19, (a)-(c) further present the temperature- and mass-dependences of Jₛ, J_{w}, and J_{w}/Jₛ of the RGO membranes. In FIG. 19, a with 1.5 M Na₂SO₄ draw solution, the reverse flux selectivity increases significantly with temperature initially and then reaches a plateau at 160° C., while both the reverse salt flux and the water flux decrease with temperature, with more significant decrease in the reverse salt flux as the temperature increases from 150 to 160° C. In FIG. 19, b with 1 M NaCl draw solution, both the reverse salt flux and the water flux decrease gradually with temperature in a similar level, resulting in only slight increase of the reverse flux selectivity with temperature. In FIG. 19, c, increasing the RGO mass loadings improves reverse flux selectivity significantly from 460 L/mol at 0.08 mg to 6500 L/mol at 0.25 mg. In FIG. 19, d with samples treated under nitrogen atmosphere, with 1.5 M Na₂SO₄ draw solution, the reverse flux selectivity was maximized at ˜155-160° C., while both the reverse salt flux and the water flux decrease with temperature, with more significant changes in the reverse salt flux as the temperature increases from 150 to 170° C. In comparison, the RGO membranes treated in air have higher reverse flux selectivity with higher water flux than those treated under nitrogen at 170° C. Under the nitrogen atmosphere, the removal of oxygen functional groups from GO could be more efficient, thus possibly producing RGO membranes that are less hydrophilic than those under the air atmosphere, as observed in the FO measurements where J_{w} of a RGO membrane treated in N₂ is lower than that of a RGO membrane treated in air under the same annealing temperature, in particular, at a higher temperature of 170° C.

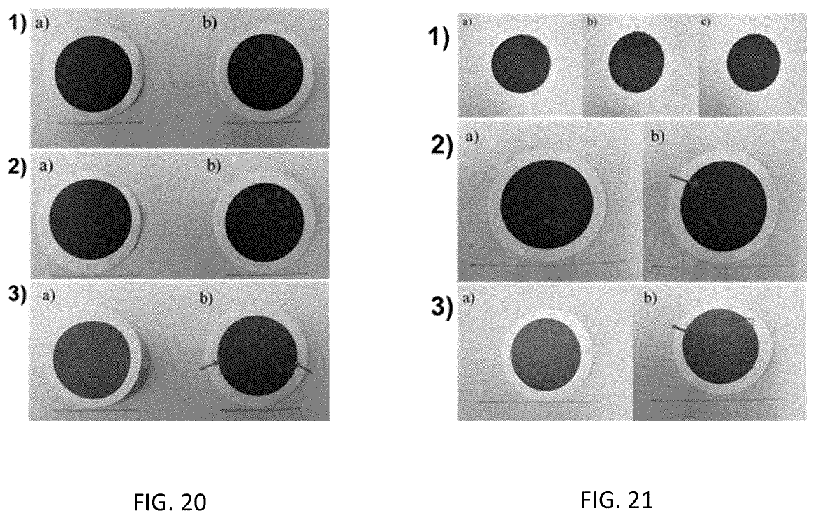

Mechanical Strength and Physical Stability of RGO Membranes. The mechanical robustness of the RGO membranes was examined after FO tests by inspecting if there were any damages on an RGO membrane around the area where the FO test O-ring was applied to, and further evaluated with a tape peel test. The thermally annealed RGO membranes on nylon membranes prepared in both air and N₂ atmospheres have no O-ring damage after FO tests (FIGS. 20-22), suggesting excellent mechanical strength of the RGO membranes. In comparison, the RGO membrane without thermal annealing shows the O-ring damages after the FO test (FIGS. 20-23). For the tape peeling test, as shown in FIG. 21, the RGO on nylon membrane annealed in nitrogen has no damage after the tape is peeled off. In comparison, the RGO on nylon membrane annealed in air is not as robust as the RGO on nylon membrane annealed in nitrogen. A small damage area is observed after the tape is peeled off (FIG. 21-2). In contrast, there is significant damage on the RGO membrane without thermal annealing (FIG. 21-23), suggesting the importance of thermal treatment to stabilize the RGO membranes on nylon.

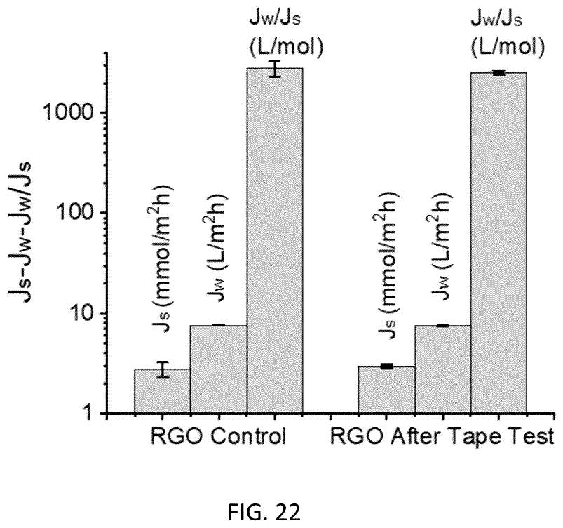

To further evaluate the physical stability of the RGO on nylon membrane annealed in nitrogen after the tape peel test, a follow-up FO test was conducted to confirm if the membrane retained its FO performance after the tape peel test, in comparison with the RGO membrane without the tape peel test, as shown in FIG. 22. The t test indicates that there are no significant differences at 95% confidence in the reverse flux selectivity (J_{w}/Jₛ) of RGO membranes with and without tape peel tests, further confirming the visual evaluation.

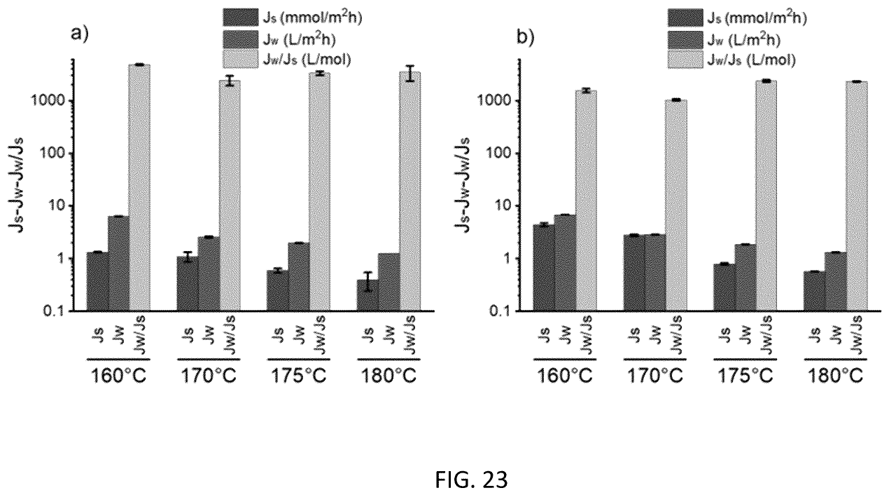

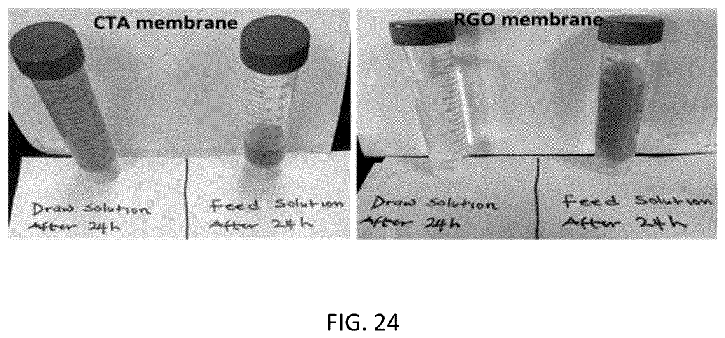

FO Performance after Exposure to DI Water for 30 Days. The long-term stability of RGO membranes when exposed to water was further examined. The FO performance of the RGO membranes annealed at different temperatures before and after exposure to water for 30 days is presented in FIG. 23.

As can be seen in FIG. 23, before and after exposure to DI water for 30 days, all membranes tested show the values of J_{w}/Jₛ larger than 1000 L/mol, still better than that of CTA membranes (FIG. 7, b). The water flux stays almost the same before and after the 30-day water exposure. However, the reverse salt flux increases after the exposure, with less change at higher annealing temperature. As a result, the higher the annealing temperature, the less decrease the reverse flux selectivity. The t test results listed in Table 2 indicate that there are significant differences at 95% confidence in the reverse flux selectivity (J_{w}/Jₛ) of RGO membranes annealed at 160-175° C. before and after 30-day water exposure, indicating those membranes could still swell to some degrees under long-term exposure to water. However, no significant differences at 95% confidence exist in the reverse flux selectivity (J_{w}/Jₛ) of RGO membranes annealed at 180° C. before and after exposure, suggesting the robustness of the RGO membranes against the water swelling.

TABLE 2
Summary of reverse flux selectivity of RGO membranes before and after exposure
to water for 30 days and the values F_{calculated}, t_{calculated}, and t_{table} (95%).

| | Before | | After | | | | |
|---|---|---|---|---|---|---|---|
| RGO | J_{w}/Jₛ | | J_{w}/Jₛ | | | | t_{table} |
| Samples | (L/mol) | n₁ | (L/mol) | n₂ | F_{calculated} | t_{calculated} | (95%) |
| 160° C. | 4800 ± 100 | 3 | 1600 ± 100 | 3 | 1.₀ | 4.₀ × 10 | 2.776 |
| 170° C. | 2400 ± 500 | 3 | 1000 ± 30 | 3 | 2.₈ × 10² | 4.₈ | 4.303 |
| 175° C. | 3300 ± 300 | 3 | 2400 ± 100 | 3 | 9.₀ | 4.₉ | 2.776 |
| 180° C. | 3500 ± 1100 | 3 | 2300 ± 40 | 3 | 7.₆ × 10² | 1.₉ | 4.303 |

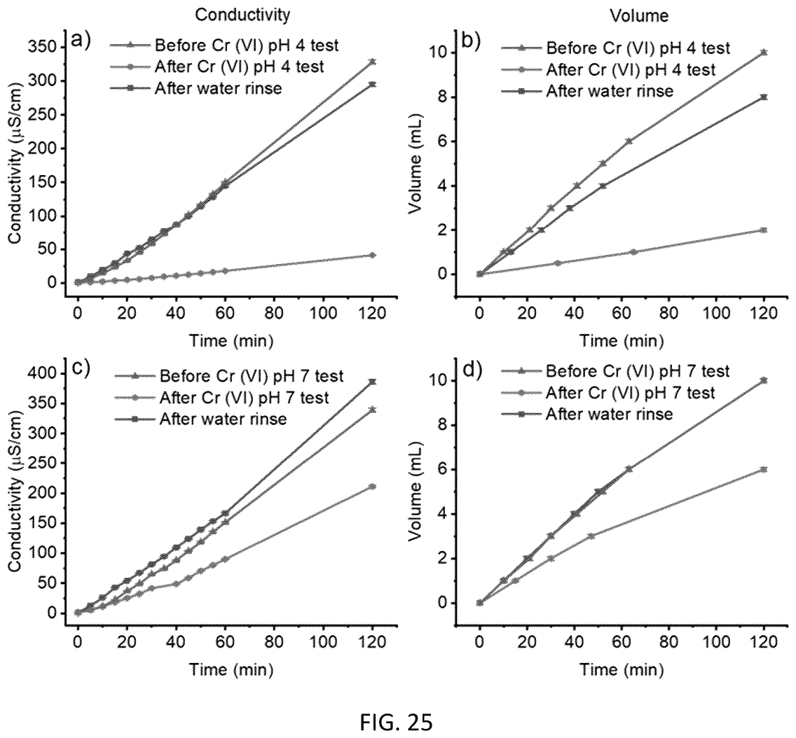

Oxidation Resistance of RGO Membranes. The chemical stability of RGO membranes with Cr (VI) solution was examined by using Cr (VI) as a feed solution and 2 M sucrose as a draw solution. A high Cr (VI) concentration of 6,000 mg/L was chosen (0.1154 M Na₂CrO₄ or 0.0577 M Na₂Cr₂O₇), about 20 times larger than the initial Cr (VI) concentration in the chromium waste brine and ˜3 times larger than the concentrated Cr (VI) concentration after the FO test. The tests were under pH 4.05 and 7.00 for feed solutions. As a comparison, FO tests on CTA membranes were also conducted under identical conditions. For comparison, FIG. 24 shows the photos of the draw solutions and the feed solutions after 24-hour FO tests at pH 4.05. The draw solution with the CTA membrane had a much deeper color than that with the RGO membrane. The conductivity of CTA draw solution changed from 0.24 to 1,184 μS/cm in 24 h, significantly larger than that in RGO draw solution which only changed from 0.24 to 6.18 μS/cm. On the other hand, the volume change of CTA draw solution was 38 mL in 24 h, about three times larger than 13 mL of RGO draw solution.

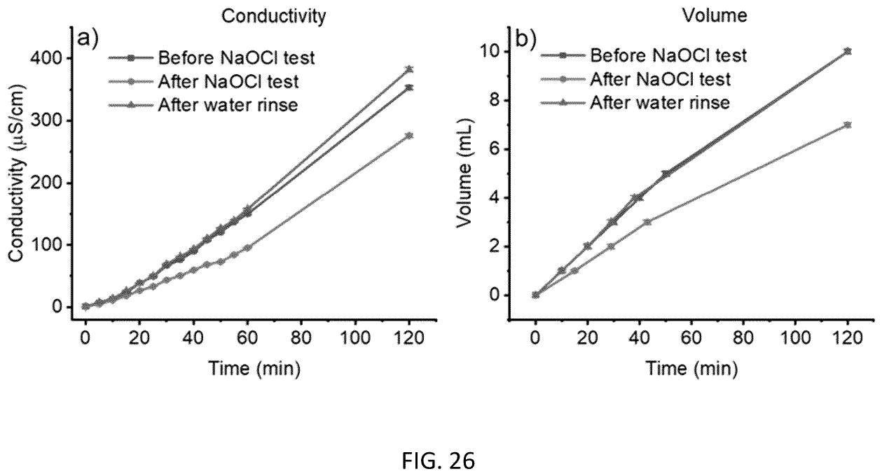

The deeper color and the large conductivity increase in CTA draw solution indicated the possible damage of the CTA membrane by Cr (VI) oxidation. To confirm that, we conducted additional FO tests by using DI water as a feed solution and 1 M NaCl as a draw solution on the CTA membrane before and after contacting Cr (VI) feed solution in FO. With the almost same volume changes in the 2 h FO tests, the conductivity of the feed solution changed from 154.1 μS/cm before contacting with Cr (VI) to 1,206 μS/cm after contacting with Cr (VI). The ˜8-time increase in conductivity after contacting with Cr (VI) suggests substantial damage of the CTA membrane by Cr (VI) oxidation. However, as shown in FIG. 25, the RGO membrane shows a completely different behavior from the CTA membrane. After contacting with Cr (VI), the conductivity of the RGO feed solution decreases substantially in the 2 h FO test, so does the volume change (FIG. 25, b). The result suggests that the RGO membrane becomes less permeable for both water and ions after contacting Cr (VI), indicating some degree of chemical interaction between the RGO membrane and Cr (VI). However, after water rinsing, the FO performance of the RGO membrane is recovered fully for conductivity and by more than 80% for volume change (FIGS. 25a, b), even after contacting Cr (VI) (over 6,000 mg/L) for 24 h. Similar result is observed at pH 7.00 in FIGS. 25, c, d. However, the magnitude of the changes is less than that in pH 4.05, possibly due to the less oxidation power of Cr (VI) at higher pH levels. Similar results were observed with 200 ppm NaOCl (FIG. 26), except that the magnitude of the changes was less than that with chromate. The FO performance of the RGO membranes was recovered after water rinse (FIG. 26). Those oxidation resistance results of RGO membranes will be reported elsewhere in detail.

Alternative Application Potential of RGO FO Membranes. Here we have further demonstrated that one can reduce waste brine volume while simultaneously harvesting osmotic energy as electricity. Waste brine management is the key economic barrier for utilizing ion exchange (IX) processes to remove specific inorganic contaminants. In a recent study conducted by Arias-Paic and Korak, it has been demonstrated that FO can reduce chromium and nitrate waste brine disposal volumes and its integration with other water purification methods such as IX could significantly reduce the cost of water recovery operations.

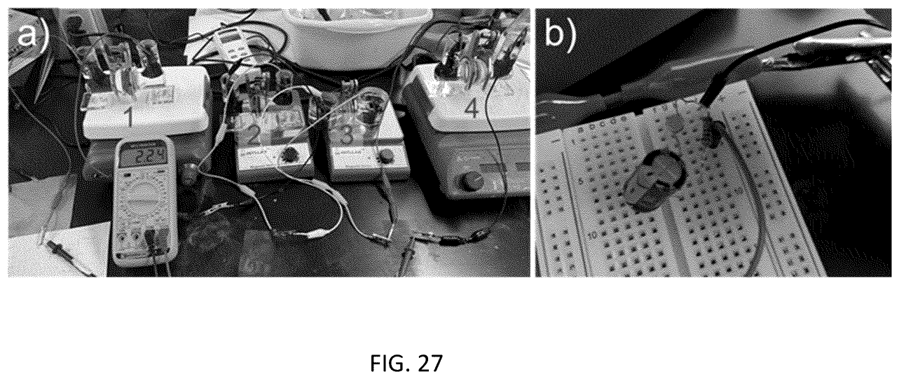

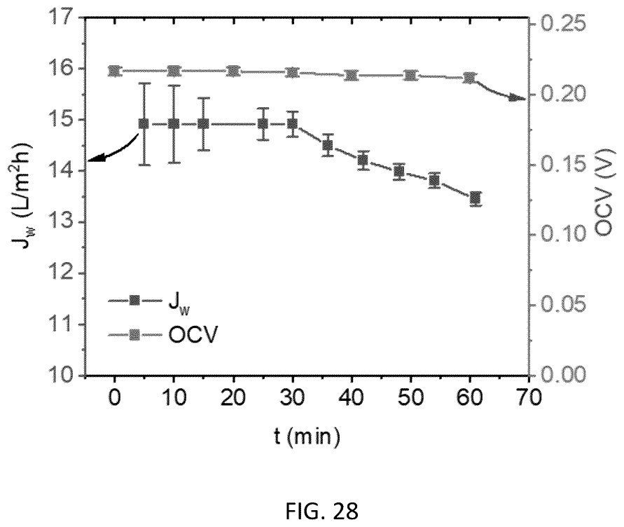

In addition, due to the high salinity difference between the feed solution and the draw solution, there is considerable osmotic energy stored in the FO processes. As another form of RED, nanopore-based power generation (NPG) directly harvests the osmotic energy as electricity by utilizing membranes that separate the two solutions of different salinities. High power densities of up to 106 W/m² on single nanopores and 67 W/m² on nanofluidic membranes have been reported. Almost all power density tests have been conducted with extremely small areas on single nanopores and nanofluidic membranes, and most of the up-scaled membranes have power densities less than 5 W/m². The negatively charged RGO membranes as shown in FIG. 1, B will preferentially reject anions, causing some leakage of cations from the draw solution to the feed solution, inherently producing electricity in the FO process. By using as-prepared RGO membranes, we have demonstrated that one can harvest the osmotic energy as electricity with an open-circuit voltage (OCV) of 2.24 V with four FO devices connected in series to power LED light (FIG. 27), while simultaneously concentrating waste brine volume in the FO processes (FIG. 28). As a primary test by using the waste brine from Alamogordo Brackish Groundwater National Desalination Research Facility (Pond 3, conductivity 72 mS/cm or ˜37,000 mg/L TDS) as a feed solution and 26 wt % NaCl (˜240 mS/cm or ˜320,000 mg/L) as a draw solution under the stationary condition, we have obtained a water flux of ˜14 L/m²h for wastewater volume reduction while harvesting the osmotic energy as electricity with an OCV of ˜0.21 V (FIG. 28), which otherwise is not collected and therefore wasted in the traditional FO process. The detailed results will be further reported elsewhere.

The above results suggest that based on earth-abundant salts, the RGO FO membranes may enable a new type of novel batteries-osmotic batteries, using clean osmotic energy. In the FO process, the osmotic battery works in a mimetic way as the discharging lithium-ion batteries. The process may also simultaneously store the osmotic energy as intercalated salts in the RGO membrane by taking advantage of concentration polarization. It could be in the form of miniaturized systems by incorporating hundreds and thousands of miniaturized devices arranged in combined series-parallel circuit configurations. By slowly releasing the charge (low current per device), long-term operation could be achieved. The systems could power electronic devices, neuromorphic computing, sensors, Internet of Things (IoT) devices, and other energy applications in remote or off-grid locations where water and salts (e.g., wastewater and brines) are available. For applications which require large-area GO/RGO membranes, several research groups have synthesized GO/RGO membranes with a dimension of 120 cm×35 cm, 150 mm and 290 mm in diameter by vacuum filtration. Kaner et al. have employed a novel thin-film lift off technique in combination with the blade coating method to make mechanically robust nanostructured membranes using large-area and well aligned GO nanofilms. Large-area GO/RGO membranes can also be prepared by a gravure printing technique where the membrane size is only limited by the size of the gravure machine. In combination with a heat gun technique, the printed GO membranes can be in situ thermally reduced to RGO membranes under controlled temperatures and atmospheres.

### CONCLUSIONS

In combination with structure characterization, we have systematically studied a variety of factors for fabricating thermally reduced graphene oxide (RGO) forward osmosis membranes. XPS reveals that the nanoporous GO sheets have almost constant C/O ratio with the atomic ratio C_{C}:C_{O}:O˜1.1:1.1:1 in the pristine and nanoporous GO samples under different hydrogen peroxide oxidation times. The thermal annealing leads to the partial restoration of π conjugation of RGO membranes with narrower interlayer spacing. After saturated with water, the interlayer spacing of RGO membranes between 0.84 and 1.04 nm, capable of rejecting some small ions and molecules occurs at a narrow temperature range between 155 and 170° C. We have demonstrated that an exceptionally large reverse flux selectivity (6700 L/mol) of the RGO membranes on nylon filter membranes have been obtained with 1.5 M sodium sulfate draw solution, about 7 times larger than that of commercial cellulose triacetate membranes under the same testing condition. The RGO membranes are mechanically strong and can withstand the tape peel tests without losing superior FO performance. They also possess enhanced water swelling resistance, oxidation resistance against Cr (VI) and hypochlorite, and application potential for reducing wastewater volumes and harvesting osmotic energy as electricity simultaneously, uniquely attractive for wastewater management, selective chemical enrichments, and carbon-negative energy applications.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### REFERENCES

[1]. Hoover, L. A.; Phillip, W. A.; Tiraferri, A.; Yip, N. Y.; Elimelech, M. Forward with Osmosis: Emerging Applications for Greater Sustainability. Environ. Sci. Technol. 2011, 45, 9824-9830.
[2]. Chia, W. Y.; Chia, S. R.; Khoo, K. S.; Chew, K. W.; Show, P. L. Sustainable Membrane Technology for Resource Recovery from Wastewater: Forward Osmosis and Pressure Retarded Osmosis. J. Water Process Eng. 2021, 39, 101758.
[3]. Korak, J.; Arias-Paic, M. Forward Osmosis Evaluation and Applications for Reclamation. U.S. Department of the Interior, Bureau of Reclamation, Research and Development Office: Final Report 2015-01-7911, 2015.
[4]. Coday, B. D.; Xu, P.; Beaudry, E. G.; Herron, J.; Lampi, K.; Hancock, N. T.; Cath, T. Y. The Sweet Spot of Forward Osmosis: Treatment of Produced Water, Drilling Wastewater, and Other Complex and Difficult Liquid Streams. Desalination 2014, 333, 23-35.
[5]. Wu, W.; Shi, Y.; Liu, G.; Fan, X.; Yu, Y. Recent Development of Graphene Oxide Based Forward Osmosis Membrane for Water Treatment: A Critical Review. Desalination 2020, 491, 114452.
[6]. Tong, X.; Wang, X.; Liu, S.; Gao, H.; Hao, R.; Chen, Y. Low-Grade Waste Heat Recovery via an Osmotic Heat Engine by Using a Freestanding Graphene Oxide Membrane. ACS Omega 2018, 3, 15501-15509.
[7]. Arias-Paic, M.; Korak, J. Forward Osmosis for Ion Exchange Waste Brine Management. Environ. Sci. Technol. Lett. 2020, 7, 111-117.
[8]. Verbeke, R.; Davenport, D. M.; Stassin, T.; Eyley, S.; Dickmann, M.; Cruz, A. J.; Dara, P.; Ritt, C. L.; Bogaerts, C.; Egger, W.; al, e. Chlorine-Resistant Epoxide-Based Membranes for Sustainable Water Desalination. Environ. Sci. Technol. Lett. 2021, 8, 818-824.
[9]. Logan, B. E.; Elimelech, M. Membrane-Based Processes for Sustainable Power Generation Using Water. Nature 2012, 488, 313-319.
[10]. Pattle, R. E. Production of Electric Power by Mixing Fresh and Salt Water in the Hydroelectric Pile. Nature 1954, 174, 660-660.
[11]. Gao, H.; Chen, W.; Xu, C.; Liu, S.; Tong, X.; Chen, Y. Two-Dimensional Ti3C2Tx MXene/GO Hybrid Membranes for Highly Efficient Osmotic Power Generation. Environ. Sci. Technol. 2020, 54, 2931-2940.
[12]. Wang, L.; Wang, Z.; Patel, S. K.; Lin, S.; Elimelech, M. Nanopore-Based Power Generation from Salinity Gradient: Why It Is Not Viable. ACS Nano 2021, 15, 4093-4107.
[13]. Mi, B. Scaling Up Nanoporous Graphene Membranes. Science 2019, 364, 1033-1034.
[14]. Wang, Z.; Tu, Q.; Zheng, S.; Urban, J. J.; Li, S.; Mi, B. Understanding the Aqueous Stability and Filtration Capability of MoS₂ Membranes. Nano Lett. 2017, 17, 7289-7298.
[15]. Abraham, J.; Vasu, K. S.; Williams, C. D.; Gopinadhan, K.; Su, Y.; Cherian, C. T.; Dix, J.; Prestat, E.; Haigh, S. J.; Grigorieva, I. V.; Carbone, P.; Geim, A. K.; Nair, R. R. Tunable Sieving of Ions Using Graphene Oxide Membranes. Nat. Nanotechnol. 2017, 12, 546-550.
[16]. Lu, X.; Gabinet, U. R.; Ritt, C. L.; Feng, X.; Deshmukh, A.; Kawabata, K.; Kaneda, M.; Hashmi, S. M.; Osuji, C. O.; Elimelech, M. Relating Selectivity and Separation Performance of Lamellar Two-Dimensional Molybdenum Disulfide (MoS₂) Membranes to Nanosheet Stacking Behavior. Environ. Sci. Technol. 2020, 54, 9640-9651.
[17]. Liu, H.; Wang, H.; Zhang, X. Facile Fabrication of Freestanding Ultrathin Reduced Graphene Oxide Membranes for Water Purification. Adv. Mater. 2015, 27, 249-254.
[18]. Pei, J.; Zhang, X.; Huang, L.; Jiang, H.; Hu, X. Fabrication of Reduced Graphene Oxide Membranes for Highly Efficient Water Desalination. RSC Adv. 2016, 6, 101948.
[19]. Li, D.; Müller, M. B.; Gilje, S.; Kaner, R. B.; Wallace, G. G. Processable Aqueous Dispersions of Graphene Nanosheets. Nat. Nanotechnol. 2008, 3, 101-5.
[20]. Li, Y.; Zhao, W.; Weyland, M.; Yuan, S.; Xia, Y.; Liu, H.; Jian, M.; Yang, J.; Easton, C. D.; Selomulya, C.; Zhang, X. Thermally Reduced Nanoporous Graphene Oxide Membrane for Desalination. Environ. Sci. Technol. 2019, 53, 8314-8323.
[21]. Kim, J.; Lee, S. E.; Seo, S.; Woo, J. Y.; Han, C.-S. Near-Complete Blocking of Multivalent Anions in Graphene Oxide Membranes with Tunable Interlayer Spacing from 3.7 to 8.0 Angstrom. J. Membr. Sci. 2019, 592, 117394.
[22]. Huang, H.-H.; Joshi, R. K.; De Silva, K. K. H.; Badam, R.; Yoshimura, M. Fabrication of Reduced Graphene Oxide Membranes for Water Desalination. J. Membr. Sci. 2019, 572, 12-19.
[23]. Wang, D. Y.; Watanabe, F.; Zhao, W. One-Pot Growth of 3D Reduced Graphene Oxide Foams Embedded with NiFe Oxide Nanocatalysts for Oxygen Evolution Reaction. J. Electrochem. Soc. 2016, 163, F3158-F3163.
[24]. Wang, D. Y.; Watanabe, F.; Zhao, W. Reduced Graphene Oxide-NiO Nanomembranes as Oxygen Evolution Reaction Electrocatalysts. ECS J. Solid State Sci. Technol. 2017, 6, M3049-M3054.
[25]. Yu, P.; Xiong, Z.; Zhan, H.; Xie, K.; Zhong, Y. L.; Simon, G. P.; Li, D. Electrochemically-Derived Graphene Oxide Membranes with High Stability and Superior Ionic Sieving. Chem. Commun. 2019, 55, 4075-4078.
[26]. Zhang, W.-H.; Yin, M.-J.; Zhao, Q.; Jin, C.-G.; Wang, N.; Ji, S.; Ritt, C. L.; Elimelech, M.; An, Q.-F. Graphene Oxide Membranes with Stable Porous Structure for Ultrafast Water Transport. Nat. Nanotechnol. 2021, 16, 337-343.
[27]. Chen, L.; Shi, G.; Shen, J.; Peng, B.; Zhang, B.; Wang, Y.; Bian, F.; Wang, J.; Li, D.; Qian, Z.; Xu, G.; Liu, G.; Zeng, J.; Zhang, L.; Yang, Y.; Zhou, G.; Wu, M.; Jin, W.; Li, J.; Fang, H. Ion Sieving in Graphene Oxide Membranes via Cationic Control of Interlayer Spacing. Nature 2017, 550, 380-383.
[28]. Chen, J.; Liu, X.; Ding, Z.; He, Z.; Jiang, H.; Zhu, K.; Li, Y.; Shi, G. Multistage Filtration Desalination via Ion Self-Rejection Effect in Cation-Controlled Graphene Oxide Membrane under 1 Bar Operating Pressure. Nano Lett. 2023.
[29]. Liu, D.; Xiong, Z.; Wang, P.; Liang, Q.; Zhu, H.; Liu, J. Z.; Forsyth, M.; Li, D. Ion-Specific Nanoconfinement Effect in Multilayered Graphene Membranes: A Combined Nuclear Magnetic Resonance and Computational Study. Nano Lett. 2023, 23, 5555-5561.
[30]. Yang, X.; Cheng, C.; Wang, Y.; Qiu, L.; Li, D. Liquid-Mediated Dense Integration of Graphene Materials for Compact Capacitive Energy Storage. Science 2013, 341, 534-537.
[31]. Cheng, C.; Jiang, G.; Garvey, C. J.; Wang, Y.; Simon, G. P.; Liu, J. Z.; Li, D. Ion Transport in Complex Layered Graphene-Based Membranes with Tuneable Interlayer Spacing. Sci. Adv. 2016, 2, e1501272.
[32]. Marcano, D. C.; Kosynkin, D. V.; Berlin, J. M.; Sinitskii, A.; Sun, Z.; Slesarev, A.; Alemany, L. B.; Lu, W.; Tour, J. M. Improved Synthesis of Graphene Oxide. ACS Nano 2010, 4, 4806-4814.
[33]. Chen, X.; Feng, Z.; Gohil, J.; Stafford, C. M.; Dai, N.; Huang, L.; Lin, H. Reduced Holey Graphene Oxide Membranes for Desalination with Improved Water Permeance. ACS Appl. Mater. Interfaces 2020, 12, 1387-1394.
[34]. Palaniselvam, T.; Valappil, M. O.; Illathvalappil, R.; Kurungot, S. Nanoporous graphene by quantum dots removal from graphene and its conversion to a potential oxygen reduction electrocatalyst via nitrogen doping. Energy Environ. Sci. 2014, 7, 1059-1067.
[35]. Faria, A. F.; Perreault, F.; Elimelech, M. Elucidating the Role of Oxidative Debris in the Antimicrobial Properties of Graphene Oxide. ACS Appl. Nano Mater. 2018, 1, 1164-1174.
[36]. Kim, D. W.; Jang, J.; Kim, I.; Nam, Y. T.; Jung, Y.; Jung, H.-T. Revealing the Role of Oxygen Debris and Functional Groups on the Water Flux and Molecular Separation of Graphene Oxide Membrane: A Combined Experimental and Theoretical Study. J. Phys. Chem. C 2018, 122, 17507-17517.
[37]. Qian, Y.; Liu, D.; Yang, G.; Wang, L.; Liu, Y.; Chen, C.; Wang, X.; Lei, W. Boosting Osmotic Energy Conversion of Graphene Oxide Membranes via Self-Exfoliation Behavior in Nano-Confinement Spaces. J. Am. Chem. Soc. 2022, 144, 13764-13772.
[38]. Lu, X.; Feng, X.; Zhang, X.; Chukwu, M. N.; Osuji, C. O.; Elimelech, M. Fabrication of a Desalination Membrane with Enhanced Microbial Resistance through Vertical Alignment of Graphene Oxide. Environ. Sci. Technol. Lett. 2018, 5, 614-620.
[39]. Zhang, H.-L.; Han, S.-J. Viscosity and Density of Water+Sodium Chloride+Potassium Chloride Solutions at 298.15 K. J. Chem. Eng. Data 1996, 41, 516-520.
[40]. Achilli, A.; Cath, T. Y.; Childress, A. E. Selection of Inorganic-Based Draw Solutions for Forward Osmosis Applications. J. Membr. Sci. 2010, 364, 233-241.
[41]. Phillip, W. A.; Yong, J. S.; Elimelech, M. Reverse Draw Solute Permeation in Forward Osmosis: Modeling and Experiments. Environ. Sci. Technol. 2010, 44, 5170-5176.
[42]. Long, Q.; Qi, G.; Wang, Y. Evaluation of Renewable Gluconate Salts as Draw Solutes in Forward Osmosis Process. ACS Sustainable Chem. Eng. 2016, 4, 85-93.
[43]. Tiraferri, A.; Yip, N. Y.; Straub, A. P.; Romero-Vargas Castrillon, S.; Elimelech, M. A Method for the Simultaneous Determination of Transport and Structural Parameters of Forward Osmosis Membranes. J. Membr. Sci. 2013, 444, 523-538.
[44]. Li, M.; Karanikola, V.; Zhang, X.; Wang, L.; Elimelech, M. A Self-Standing, Support-Free Membrane for Forward Osmosis with No Internal Concentration Polarization. Environ. Sci. Technol. Lett. 2018, 5, 266-271.
[45]. Longinotti, M. P.; Mazzobre, M. F.; Buera, M. P.; Corti, H. R. Effect of Salts on the Properties of Aqueous Sugar Systems in Relation to Biomaterial Stabilization Part 2. Sugar Crystallization Rate and Electrical Conductivity Behavior. Phys. Chem. Chem. Phys. 2002, 4, 533-540.
[46]. Gupta, A.; Sharma, C. P.; Arnusch, C. J. Simple Scalable Fabrication of Laser-Induced Graphene Composite Membranes for Water Treatment. ACS ES&T Water 2021, 1, 881-887.
[47]. Hu, R.; He, Y.; Huang, M.; Zhao, G.; Zhu, H. Strong Adhesion of Graphene Oxide Coating on Polymer Separation Membranes. Langmuir: the ACS journal of surfaces and colloids 2018, 34, 10569-10579.
[48]. Chen, D.; Feng, H.; Li, J. Graphene Oxide: Preparation, Functionalization, and Electrochemical Applications. Chem. Rev. 2012, 112, 6027-6053.
[49]. Li, C.; Zheng, Z.; Zhou, W.; Watanabe, F.; Zhao, W. NiFe Oxide Nanocatalysts Grown on Carbonized Algal Cells for Enhanced Oxygen Evolution Reaction. J. Electrochem. Soc. 2018, 165, J3157-J3165.
[50]. Perrozzi, F.; Prezioso, S.; Ottaviano, L. Graphene Oxide: From Fundamentals to Applications. J. Phys.: Condens. Matter 2015, 27, 013002.
[51]. Bagri, A.; Mattevi, C.; Acik, M.; Chabal, Y. J.; Chhowalla, M.; Shenoy, V. B. Structural Evolution during the Reduction of Chemically Derived Graphene Oxide. Nat. Chem. 2010, 2, 581-587.
[52]. Mattevi, C.; Eda, G.; Agnoli, S.; Miller, S.; Mkhoyan, K. A.; Celik, O.; Mastrogiovanni, D.; Granozzi, G.; Garfunkel, E.; Chhowalla, M. Evolution of Electrical, Chemical, and Structural Properties of Transparent and Conducting Chemically Derived Graphene Thin Films. Adv. Funct. Mater. 2009, 19, 2577-2583.
[53]. Yang, Y.; Yang, X.; Liang, L.; Gao, Y.; Cheng, H.; Li, X.; Zou, M.; Cao, A.; Ma, R.; Yuan, Q.; Duan, X. Large-Area Graphene-Nanomesh/Carbon-Nanotube Hybrid Membranes for Ionic and Molecular Nanofiltration. Science 2019, 364, 1057-1062.
[54]. Nightingale, E. R., Jr. Phenomenological Theory of Ion Solvation. Effective Radii of Hydrated Ions. J. Phys. Chem. 1959, 63, 1381-1387.
[55]. Graphene Oxide. https://www.sigmaaldrich.com/US/en/product/aldrich/796034 (accessed Nov. 17, 2023).
[56]. Reduced Graphene Oxide. https://www.azonano.com/article.aspx?ArticleID=4041 (accessed Nov. 17, 2023).
[57]. Jang, J.; Park, I.; Chee, S.-S.; Song, J.-H.; Kang, Y.; Lee, C.; Lee, W.; Ham, M.-H.; Kim, I. S. Graphene Oxide Nanocomposite Membrane Cooperatively Cross-Linked by Monomer and Polymer Overcoming the Trade-off between Flux and Rejection in Forward Osmosis. J. Membr. Sci. 2020, 598, 117684.
[58]. Nosrati, H.; Sarraf-Mamoory, R.; Karimi Behnagh, A.; Zolfaghari Emameh, R.; Aidun, A.; Le, D. Q. S.; Canillas Perez, M.; Bünger, C. E. Comparison of the Effect of Argon, Hydrogen, and Nitrogen Gases on the Reduced Graphene Oxide-Hydroxyapatite Nanocomposites Characteristics. BMC Chem 2020, 14, 59.
[59]. Harris, D. C. Quantitative Chemical Analysis. 8th ed.; W. H. Freeman: New York, NY, 2010.
[60]. Harris, D. C. Exploring Chemical Analysis. 5th ed.; W. H. Freeman: New York, NY, 2013.
[61]. Muirhead, D.; Carter, L.; Williamson, J. Preventing Precipitation in the ISS Urine Processor. In 48th International Conference on Environmental Systems, Albuquerque, New Mexico, ICES-2018-87, 2018.
[62]. Bandara, P. C.; Peña-Bahamonde, J.; Rodrigues, D. F. Redox Mechanisms of Conversion of Cr (VI) to Cr (III) by Graphene Oxide-Polymer Composite. Sci. Rep. 2020, 10, 9237.
[63]. Korak, J.; Flint, L. C.; Arias-Paic, M. Decreasing Waste Brine Volume from Anion Exchange with Nanofiltration: Implications for Multiple Treatment Cycles. Environ. Sci.: Water Res. Technol. 2021, 7, 886-903.
[64]. Laucirica, G.; Toimil-Molares, M. E.; Trautmann, C.; Marmisolle, W.; Azzaroni, O. Nanofluidic Osmotic Power Generators-Advanced Nanoporous Membranes and Nanochannels for Blue Energy Harvesting. Chem. Sci. 2021, 12, 12874.
[65]. Tong, X.; Liu, S.; Crittenden, J.; Chen, Y. Nanofluidic Membranes to Address the Challenges of Salinity Gradient Power Harvesting. ACS Nano 2021, 15, 5838-5860.
[66]. Wang, H.; Su, L.; Yagmurcukardes, M.; Chen, J.; Jiang, Y.; Li, Z.; Quan, A.; Peeters, F. M.; Wang, C.; Geim, A. K.; Hu, S. Blue Energy Conversion from Holey-Graphene-like Membranes with a High Density of Subnanometer Pores. Nano Lett. 2020, 20, 8634-8639.
[67]. Yazda, K.; Bleau, K.; Zhang, Y.; Capaldi, X.; St-Denis, T.; Grutter, P.; Reisner, W. W. High Osmotic Power Generation via Nanopore Arrays in Hybrid Hexagonal Boron Nitride/Silicon Nitride Membranes. Nano Lett. 2021, 21, 4152-4159.
[68]. Robin, P.; Emmerich, T.; Ismail, A.; Niguès, A.; You, Y.; Nam, G.-H.; Keerthi, A.; Siria, A.; Geim, A. K.; Radha, B.; Bocquet, L. Long-Term Memory and Synapse-Like Dynamics in Two-Dimensional Nanofluidic Channels. Science 2023, 379, 161-167.
[69]. Xiong, T.; Li, C.; He, X.; Xie, B.; Zong, J.; Jiang, Y.; Ma, W.; Wu, F.; Fei, J.; Yu, P.; Mao, L. Neuromorphic functions with a polyelectrolyte-confined fluidic memristor. Science 2023, 379, 156-161.
[70]. Chua, L.; Sirakoulis, G. C.; Adamatzky, A. Handbook of Memristor Networks. Springer: 2019.
[71]. Wang, Z.; Ma, C.; Xu, C.; Sinquefield, S. A.; Shofner, M. L.; Nair, S. Graphene Oxide Nanofiltration Membranes for Desalination under Realistic Conditions. Nat. Sustain. 2021, 4, 402-408.
[72]. Zhang, M.; Guan, K.; Ji, Y.; Liu, G.; Jin, W.; Xu, N. Controllable Ion Transport by Surface-Charged Graphene Oxide Membrane. Nat. Commun. 2019, 10, 1253.
[73]. Wang, Z.; Ma, C.; Sinquefield, S. A.; Shofner, M. L.; Nair, S. High-Performance Graphene Oxide Nanofiltration Membranes for Black Liquor Concentration. ACS Sustainable Chem. Eng. 2019, 7, 14915-14923.
[74]. Xue, S.; Ji, C.; Kowal, M. D.; Molas, J. C.; Lin, C.-W.; Mc Verry, B. T.; Turner, C. L.; Mak, W. H.; Anderson, M.; Muni, M.; Hoek, E. M. V.; Xu, Z.-L.; Kaner, R. B. Nanostructured Graphene Oxide Composite Membranes with Ultrapermeability and Mechanical Robustness. Nano Lett. 2020, 20, 2209-2218.
[75]. Akbari, A.; Sheath, P.; Martin, S. T.; Shinde, D. B.; Shaibani, M.; Banerjee, P. C.; Tkacz, R.; Bhattacharyya, D.; Majumder, M. Large-Area Graphene-Based Nanofiltration Membranes by Shear Alignment of Discotic Nematic Liquid Crystals of Graphene Oxide. Nat. Commun. 2016, 7, 10891.
[76]. The maximum temperature for the different filter membranes. https://www.sterlitech.com/nylon-membrane-filter-ny459025.html (accessed Nov. 17, 2023).
[77]. MP, T_{g} and Structure of Common Polymers. https://resources.perkinelmer.com/corporate/cmsresources/images/44-74863tch_mptgandstructureofcommonpolymers.pdf (accessed Nov. 17, 2023).
[78]. Tristram, C. J.; Ingham, B.; Williams, D. B. G.; Hinkley, S. F. R. Determination of Glass Transitions in Novel Cellulose Polymers by Synchrotron Wide-Angle X-Ray Scattering. Materials Today Communications 2015, 2, e49-e54.
[79]. Optical Properties of Sulfone Polymers. https://www.solvay.com/sites/g/files/srpend221/files/2018-07/Sulfones-Optical-Properties_EN.pdf (accessed Feb. 4, 2024).
[80]. Thermal Transitions of Homopolymers: Glass Transition & Melting Point. https://www.sigmaaldrich.com/US/en/technical-documents/technical-article/materials-science-and-engineering/polymer-synthesis/thermal-transitions-of-homopolymers (accessed Nov. 17, 2023).
[81]. Kamide, K.; Saito, M. Thermal Analysis of Cellulose Acetate Solids with TotalDegrees of Substitution of 0.49, 1.75, 2.46, and 2.92. Polymer Journal 1985, 17, 919-928.

What is claimed is:

1. A forward osmosis (FO) membrane, comprising:
a selectively permeable active layer formed of a graphene-based material with tunable interlayer spacing; and
a support membrane providing mechanical stability;
wherein the FO membrane enhances water flux while minimizing reverse solute flux.

2. The FO membrane of claim 1, wherein the support membrane is a polymeric support membrane comprising nylon, polyethersulfone (PES), mixed cellulose ester (MCE), cellulose acetate, and/or polycarbonate (PC) with a pore size ranging from 0.03 μm to 0.8 μm.

3. The FO membrane of claim 1, wherein the free interlayer spacing is less than 0.7 nm after water exposure.

4. The FO membrane of claim 1, wherein the graphene-based material comprises reduced graphene oxide (RGO).

5. The FO membrane of claim 4, wherein the RGO active layer exhibits a reverse flux selectivity of at least 6700 L/mol when tested with a 1.5 M sodium sulfate draw solution.

6. The FO membrane of claim 4, wherein the RGO active layer is formed by thermally reducing graphene oxide (GO) sheets that are pre-treated with hydrogen peroxide oxidation and hydrothermal reactions to create nanoporous structures.

7. The FO membrane of claim 4, wherein the interlayer spacing of the RGO active layer is tunable by varying the annealing temperature between 150-190° C.

8. The FO membrane of claim 4, wherein the RGO active layer is adhered to the polymeric support membrane, providing enhanced mechanical stability as demonstrated by resistance to tape peel tests.

9. The FO membrane of claim 1, wherein the FO membrane exhibits resistance to chlorine degradation at concentrations exceeding 2 ppm and resistance to hexavalent chromium (Cr VI) oxidation.

10. The FO membrane of claim 1, wherein the FO membrane exhibits rejection rates exceeding 99.8% for salts and organic species in synthetic urine tests.

11. The FO membrane of claim 1, wherein the FO membrane demonstrates enhanced mechanical strength and chemical resistance against degradation by oxidizing agents.

12. The FO membrane of claim 1, wherein the FO membrane is used for selective chemical enrichment and desalination processes, separation and concentration of chemical species in industrial or environmental applications.

13. The FO membrane of claim 1, wherein the FO membrane is designed for long-term operational stability in high-salinity and wastewater treatment environments.

14. The FO membrane of claim 1, wherein the FO membrane is integrated into a hybrid desalination system in combination with ion exchange or reverse osmosis for improved brine management.

15. A method for fabricating a forward osmosis (FO) membrane, comprising:
synthesizing a graphene-based material;
depositing the graphene-based material onto a support membrane; and
treating the deposited material to enhance stability and selectivity.

16. The method of claim 15, wherein said synthesizing the graphene-based material comprises:
synthesizing graphene oxide (GO) sheets from natural graphite using an oxidation process;
treating the GO sheets with hydrogen peroxide oxidation for 5-10 hours to create nanoporous structures; and
subjecting the nanoporous GO sheets to hydrothermal reduction to obtain RGO suspensions.

17. The method of claim 15, wherein said depositing the graphene-based material comprises:
depositing the RGO suspensions onto a polymeric support membrane via vacuum filtration.

18. The method of claim 15, wherein said treating the deposited material comprises:
thermally annealing the deposited RGO membrane at a temperature of 150-190° C. to achieve a free interlayer spacing of less than 0.7 nm.

19. The method of claim 15, wherein the support membrane comprises nylon, PES, MCE, cellulose acetate, and/or PC with a pore size ranging from 0.03 to 0.8 μm.

20. The method of claim 15, further comprising an additional post-treatment step to enhance adhesion between the RGO layer and the support membrane, improving mechanical robustness.

21. A forward osmosis system, comprising:
an FO membrane as claimed in claim 1;
a feed solution chamber containing wastewater or brackish water; and
a draw solution chamber containing a high-salinity solution;
wherein the FO membrane simultaneously enables water transport while minimizing reverse solute flux and allows for osmotic energy harvesting as electrical energy.

22. The FO system of claim 21, further comprising electrodes positioned in the feed and draw solution chambers to capture osmotic energy as electrical output.

23. A method for harvesting osmotic energy, comprising:
utilizing a forward osmosis membrane as claimed in claim 1 to separate a high-salinity draw solution from a lower-salinity feed solution;
allowing osmotic flow across the membrane to generate an ion flux;
capturing the resulting electrochemical potential using electrodes to produce an open-circuit voltage; and
converting the captured energy into usable electrical power.

24. The method of claim 23, wherein the draw solution comprises sodium sulfate or sodium chloride at concentrations of 1.0-2.0 M.

25. The method of claim 23, wherein the osmotic energy is stored as an electrochemical charge for use in low-power electronic devices, sensors, or IoT (Internet-of-Things) applications.

26. A forward osmosis membrane-based osmotic battery, comprising:
a stack of FO membranes as claimed in claim 1, arranged in a series-parallel configuration;
alternating feed and draw solution compartments to maintain salinity gradients; and
an electrical circuit to collect and regulate the generated osmotic energy.

27. The osmotic battery of claim 26, wherein the FO membranes are printed using a gravure printing technique and thermally reduced in situ to produce large-area RGO membranes for scalable energy applications.

28. The osmotic battery of claim 26, wherein the osmotic battery operates in an off-grid environment utilizing wastewater or brine as a feed solution to generate renewable energy.

29. A method for producing large-area RGO FO membranes, comprising:
depositing GO sheets onto a flexible substrate using a blade coating or gravure printing technique;
thermally reducing the GO layer in situ using a controlled heat gun technique;
transferring the thermally reduced RGO membrane onto a polymeric support membrane for FO applications.
